(19) United States
(12) Patent Application Publication
(10) Pub. No.: US 2023/0125036 A1
(43) Pub. Date: Apr. 20, 2023

(54) NATURAL LANGUAGE INTERFACE FOR VIRTUAL ENVIRONMENT GENERATION

(71) Applicant: Microsoft Technology Licensing, LLC, Redmond, WA (US)

(72) Inventors: Ryan VOLUM, Seattle, WA (US); Karmelit Alon ALLISON, Malibu, CA (US)

(73) Assignee: Microsoft Technology Licensing, LLC, Redmond, WA (US)

(21) Appl. No.: 17/733,301

(22) Filed: Apr. 29, 2022

Related U.S. Application Data
(60) Provisional application No. 63/255,796, filed on Oct. 14, 2021.
(60) Provisional application No. 63/255,840, filed on Oct. 14, 2021.

(51) Int. Cl. A63F 13/63; G06F 3/04815; G06N 20/20; A63F 13/55

(52) U.S. Cl. CPC A63F 13/63; G06F 3/04815; G06N 20/20; A63F 13/55

(57) ABSTRACT

Aspects of the present disclosure relate to grounded multimodal agent interactions, where a natural language user input is processed using a multimodal machine learning model to generate model output. The model output may then be processed to affect the behavior of an application, for example to enable a user to control the application and/or to facilitate user interactions with a conversational agent, among other examples. In some instances, at least a part of the model output may be executed or parsed, for example to generate three dimensional objects within a coding application. Thus, use of a multimodal machine learning model according to aspects described herein may enable the use of user-provided natural language input to affect the behavior of an application accordingly.

### CROSS-REFERENCE TO RELATED APPLICATION

This application claims priority to U.S. Provisional Application No. 63/255,796, titled “Grounded Multimodal Agent Interactions,” filed on Oct. 14, 2021, and U.S. Provisional Application No. 63/255,840, titled “Grounded Multimodal Agent Interactions,” filed on Oct. 14, 2021, the entire disclosures of which are hereby incorporated by reference in their entirety.

### BACKGROUND

A user may provide input to a virtual environment or modeling application for the purpose of creating, manipulating, or otherwise interacting with said environment. However, modeling applications and associated techniques of interacting with virtual environments may be tedious and counterintuitive, such that a user may become frustrated or may otherwise be unable to effectively interact with the environment.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to generating three-dimensional objects in a virtual environment, where a natural language user input is processed using a multimodal machine learning model to generate model output. The model output may then be processed to affect the behavior of an application, for example to enable a user to control the application and/or to facilitate user interactions with a conversational agent, among other examples. In some instances, at least a part of the model output may be executed or parsed, for example to generate one or more three-dimensional objects or to otherwise manipulate a virtual environment. Thus, use of a multimodal machine learning model according to aspects described herein may enable the use of user-provided natural language input to affect the behavior of an application accordingly.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A illustrates an overview of an example system for grounded multimodal agent interactions according to aspects described herein.

FIG. 1B illustrates an overview of an example system for grounded multimodal agent interactions according to aspects described herein.

FIG. 2A illustrates an overview of an example method for affecting an application based on model output from a multimodal machine learning model according to aspects described herein.

FIG. 2B illustrates an overview of an example method for generating a multimodal response according to aspects described herein.

FIG. 3 illustrates an overview of an example method for controlling a conversational agent using a multimodal generative platform according to aspects described herein.

FIG. 4 illustrates an overview of an example method for controlling a video game application using a multimodal generative platform according to aspects described herein.

FIG. 5 illustrates an overview of an example method 500 for generating a trained multimodal generative model according to aspects described herein.

FIG. 6 illustrates an overview of an example method for training a multimodal generative model according to aspects described herein.

FIG. 7 illustrates an overview of an example method for utilizing a multimodal generative model to generate model output according to aspects described herein.

FIG. 8 illustrates an overview of an example method 800 for receiving multiple user inputs by a multimodal generative model and generating multiple model outputs, according to aspects described herein.

FIG. 9 is a block diagram illustrating example physical components of a computing device with which aspects of the disclosure may be practiced.

FIG. 10 are simplified block diagrams of a mobile computing device with which aspects of the present disclosure may be practiced.

FIG. 11 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a user may provide input to a virtual environment or modeling application for the purpose of creating, manipulating, or otherwise interacting with said environment. In some instances, the user may interact with the environment using programmatic code. However, a user may become frustrated or may be unable to easily interact with the virtual environment due to lack of familiarity with associated input techniques and/or the complexity of the virtual environment.

Accordingly, aspects of the present disclosure relate to a natural language interface for virtual environment generation. For example, a natural language user input is processed using a multimodal machine learning model to generate model output including programmatic code. In examples, the model output may be new and/or distinct lines of programmatic code for generating objects within or otherwise adapting a virtual environment. Additionally, an object generated as a result of model output may be stored for subsequent use by the multimodal machine learning model, such that the user may reference the object using natural language input.

It will be appreciated that there are various benefits of the system and methods described in the present disclosure. For example, the multimodal machine learning model is used to generate programmatic code with which a virtual environment may be adapted according to natural language input, including abstract object generation. As another example, the multimodal machine learning model may have an awareness of semantics and natural language constructs, such that comparatively complex natural language input may be processed according to aspects described herein. Additionally, the multimodal machine learning model may be used in conjunction with existing rendering libraries, application programming interfaces, and/or modeling applications. Further, the disclosed aspects may enable context-aware interactions over multiple iterations of user input (e.g., with stored reference objects and scenes based on the semantics of the natural language inputs).

In examples, user input may be processed using a generative multimodal machine learning model to generate multimodal output. The multimodal output may comprise natural language output and/or programmatic output, among other examples. The multimodal output may be processed and used to affect the state of an associated application. For example, at least a part of the multimodal output may be executed or may be used to call an application programming interface (API) of the application. As an example, the programmatic output includes code associated with an API for a three-dimensional library or modeling application. A generative multimodal machine learning model (also generally referred to herein as a multimodal machine learning model) used according to aspects described herein may be a generative transformer model, in some examples. For example, the generative multimodal machine learning model may be a code generating model thus usable to generate programmatic output based on natural language input. In some instances, explicit and/or implicit feedback may be processed to improve the performance of multimodal machine learning model.

In examples, user input and/or model output is multimodal, which, as used herein, may comprise one or more types of content. Example content includes, but is not limited to, written language (which may also be referred to herein as “natural language output”), code (which may also be referred to herein as “programmatic output”), images, video, audio, gestures, visual features, intonation, contour features, poses, styles, fonts, and/or transitions, among other examples. Thus, as compared to a machine learning model that processes natural language input and generates natural language output, aspects of the present disclosure may process input and generate output having any of a variety of content types.

It will be appreciated that all inputs and outputs for a content agent and its associated machine learning model need not be multimodal in nature. Rather, an input or output may have a single content type. For example, a user may provide input to a conversational agent that is only natural language, such that the conversational agent provides programmatic output in response, among other examples. Thus, a machine learning model according to aspects described herein may be termed to be multimodal as a result of its ability to process multiple content types. For instance, in the above example, the machine learning model interoperates between natural language and programmatic content types.

As a result of the multimodal nature of a machine learning model used by a conversational agent as described herein, a user may interact with the conversational agent to affect an application state. Examples include, but are not limited to, manipulating one or more parameters of the application, causing interactions similar to those offered by a control surface of an application (e.g., relating to a user interface element, a gesture, a keystroke, mouse input, or a menu item), causing execution of an API call, or manipulating or otherwise controlling generation of one or more types of content (e.g., textual, visual, and/or auditory content). Additional examples of such aspects are discussed in greater detail below.

Returning to the above example of multimodal interactions associated with natural language and programmatic content, natural language input received from a user may be processed to generate programmatic output, such that at least a part of the programmatic output may be executed. For example, a user may provide an instruction as natural language input, such that the machine learning model generates programmatic output that causes an application to behave as instructed by the user. For instance, the programmatic output may be a series of programmatic steps that are executed or otherwise performed by the application, thereby performing one or more complex tasks associated with an application. In examples, the programmatic output includes one or more commands associated with an API for a three-dimensional library, which may thus be executed to affect a virtual environment accordingly. Similarly, the machine learning model may generate natural language output in addition to or as an alternative to such programmatic output. In some examples, such natural language output may itself be in the form of programmatic output, for example comprising code similar to a comment or a “print” or “echo” function.

While a machine learning model may be fine-tuned for one or more specific scenarios (examples of which are discussed in greater detail below), aspects of the present application may be performed using a machine learning model that has not been specialized for such a specific scenario. As an example, a multimodal machine learning model may be primed or grounded using a prompt or other context to bias the machine learning model toward a specific behavior. For example, a prompt may provide one or more multimodal examples that illustrate a relationship between multiple content types. Thus, a prompt may be designed or generated to increase the likelihood that a model exhibits a specific behavior. In some examples, one or more such prompts may be distributed and/or (re)used in specific contexts, such that the same machine learning model may be used to reproduce different behaviors in different scenarios (e.g., where each scenario may have an associated prompt).

Returning to the above example of natural language and programmatic content, a prompt in such an example may include a text comment and an associated code segment, thereby priming the machine learning model to process similar natural language input and generate similar programmatic output. While example prompts are described, it will be appreciated that any of a variety of techniques may be used to prime a machine learning model to perform the multimodal processing aspects described herein. For instance, other techniques may be used to associate two types of content (e.g., other than a comment and associated code). Similarly, it will be appreciated that, in some examples, a machine learning model may not be primed or grounded as described above, as may be the case when a machine learning model has been fine-tuned for a given scenario.

In examples, a context may be maintained for interactions with a conversational agent. For example, a context may include a prompt as well one or more instances of user input and associated model output. Thus, such a context may enable a conversational agent to learn from previous interactions with a user, for example to correct machine learning model behavior, define new behaviors, and/or perform introspection on previous behavior, among other examples. Any of a variety of techniques may be used to maintain a context associated with a conversational agent, for example in association with a specific user, a specific user session, a specific set of users, or more generally for a larger population of users. As another example, a context may include a predetermined number of previous interactions or a machine learning model may have a limited attention with which such context affects model output generated by the machine learning model.

As used herein, a conversational agent may perform processing based on model output, for example as may be generated based on user input associated with a user. For example, the conversational agent may be a virtual assistant or a non-player character (NPC). Some examples, the conversational agent may have a visual manifestation (e.g., a virtual avatar or graphical representation), aspects of which may be controlled based on model output according to aspects described herein. In other examples, the conversational agent may be functionality integrated into an application, such that it may not have a visual manifestation. For example, a user may provide natural language input into a text box or as spoken dialogue to the application, such that the input is processed (e.g., by a conversational agent of the application) to affect behavior of the application accordingly.

In example interactions between a user and a conversational agent according to aspects described herein, user input may be received, an indication of which may be provided to a multimodal machine learning model in association with a prompt, such that the machine learning model generates model output accordingly. As noted above, the user input and the resulting model output need not be the same content type. Rather, in some examples, at least a part of the model output may be a content type that is different from the user input. The model output is processed to affect the behavior of an application, thereby enabling user control of various aspects of an application using natural language input (or any of a variety of alternative or additional types of input, in other examples).

For instance, model output obtained from a multimodal machine learning model may include programmatic output that is executed to control the behavior of the application. As an example, natural language user input may be received indicating a user request to cause an NPC to jump, move, or follow an avatar of the user, among other examples. Accordingly, the user input is processed by the multimodal machine learning model according to aspects described herein to generate programmatic output that includes a set of programmatic steps, which, when executed, cause the NPC to implement the user-requested behavior. Similar techniques may be applied to affect the behavior of an application, for example executing the programmatic output to control various functionality of the application accordingly.

In an example where the user requests that the NPC jump, the generated programmatic output may include a first programmatic step that calls a “jump” function associated with the NPC and a second programmatic step that, after a predetermined amount of time, causes the NPC to stop jumping. The programmatic output may include multiple programmatic steps. For example, in an instance where the user requests that the NPC follows the user's avatar, the generated programmatic output may include a first programmatic step that determines a location of the user avatar, a second programmatic step that causes the NPC to move toward the determined location, and a third programmatic step that causes the first and second programmatic steps to be executed after a predetermined time period. Thus, the generated programmatic output may result in a loop that periodically updates the location of the NPC based on the location of the user's avatar. As such, aspects described herein enable a user to invoke complex application functionality using natural language input, which may be tedious or difficult to achieve via a user interface or may otherwise be unavailable to the user altogether.

As noted above, the user input and/or model output may form a context that is used in subsequent interactions with the conversational agent. As an example, when a subsequent user interaction is received, a context is provided in association with the subsequent user interaction, which includes the prompt in addition to the previous user input and/or model output. Accordingly, subsequent model output is received, which may similarly be processed to the model output discussed above. Thus, subsequent user interactions with the conversational agent may be iterative in nature, where context is maintained to enable a user to correct machine learning model behavior, define new behaviors of the machine learning model and associated output, and/or request that the machine learning model perform introspection on previous behavior, among other examples. As noted above, a context may not be maintained in other examples.

In some instances, a model may fail to generate adequate model output. For example, it may be determined that a confidence level associated with the model output is below a predetermined threshold. As another example, while a multimodal machine learning model may attempt to generate content having a specific content type, the generated content may be invalid. Returning to the example or programmatic output, the resulting model output may be syntactically and/or semantically invalid, such that it is not usable to affect application behavior. For example, the model output may not conform to a specific API or may reference a user interface element or other functionality that does not exist. In such instances, an indication may be provided that a user input was not understood correctly or the user may be prompted to reformulate the provided input, among other examples. In some examples, the user input and associated model output may be stored for subsequent use as training data so as to improve model performance in the future.

As noted above, a multimodal machine learning model may be fine-tuned in some examples, for example to incorporate additional and/or more specific knowledge for a given scenario. As an example, the multimodal machine learning model may be trained using content associated with a specific scenario or domain in which it will likely be used. In the example of programmatic output, the machine learning model may be trained using relevant documentation, libraries, and code examples. Thus, in addition to or as an alternative to using a prompt to prime the machine learning model, such tuning may be used to facilitate interoperability between user input and model input having various content types. Additionally, training data generated as a result of user interactions with a conversational agent may be used to improve model performance, for example based on inputs and outputs that are logged in instances where the machine learning model fails to generate adequate model output.

Thus, aspects of the present disclosure enable more natural user interactions with a conversational agent that extend beyond simpler natural language conversation. Further, as compared to slot filling or other natural language processing techniques that map natural language input to specific application behaviors, generated model output may be more dynamic, as a machine learning model may effectively learn from user interactions and subsequently generate corrected model output accordingly. Further, rather than rigidly filling slots according to tokens identified within user input, generated model output may be adapted for any of a variety of scenarios as a result of associated prompts, context, and/or fine-tuning. In general, aspects of the present disclosure enable a user experience having tangible, technical results stemming from the application of multimodal machine learning model output to affect the behavior of an application as a result.

Aspects of the present disclosure may enable interactive development and debugging. For example, user input may be processed to generate programmatic model output, which may be executed or otherwise used to affect application behavior according to aspects described herein. Such processing may enable a user to observe an effect of the generated programmatic model output, such that the user may provide subsequent user input to correct the behavior of the machine learning model. As a result, subsequent output from the machine learning model may be improved as compared to the previous model output (e.g., by virtue of a context maintained in association with the user's interaction with the conversational agent). Similarly, user input may result in model output that exhibits new behaviors that would not have previously been generated by the machine learning model. For example, user input may correct model output syntax, API calls, or other content. As another example, the resulting model output and associated processing may enable a user to access functionality of an application that may not otherwise be (easily) accessible to a user, for example as a result of combining functionality associated with multiple controls and/or control surfaces of the application.

Aspects of the present disclosure may be used to control a video game application. As an example, functionality and/or other parameters of the video game application may be controlled based on user input (e.g., which may be received as natural language input). For example, the user input may be processed to generate model output associated with one or more API calls, user interface elements, or other commands of the video game. Similar to the above-discussed debugging aspects, a user may iteratively refine behavior exhibited by the conversational agent in instances where model output and resulting behavior is not what the user expects. In some instances, model output may ultimately yield a macro, where functionality of the video game application is combined in response to a user input, such that the user may invoke the macro to affect behavior of the video game application accordingly.

As another example, a prompt may define a persona associated with a conversational agent of a video game, such as an NPC, narrator, or virtual assistant. As used herein, a persona of a conversational agent may be associated with a dialogue tone, role, objective or goal, personality, one or more mannerisms or animations, and/or physical appearance, among other examples. For example, an NPC may have a role of shopkeeper or guide, while further having an associated objective (e.g., to sell as many items as possible or to help the user complete a task). Thus, the role of the NPC may remain substantially constant or may gradually evolve during gameplay, while the objective of the NPC may be comparatively more dynamic (e.g., according to a given context).

Further, two or more NPCs may each have the same or similar roles while having different objectives, or vice versa. As another example, an NPC may have multiple objectives that may be consistent with one another or may conflict with one another. In such as an example, one objective may therefore receive a higher weight or greater attention as compared to another objective (e.g., depending on the context). Thus, the prompt may include an indication as to an NPC's attitude, tone, role, or objective, among other such persona attributes.

A “user” as used herein may be a developer of a video game application (e.g., utilizing interactive debugging and/or defining a persona of an NPC), a developer of an application (e.g., utilizing coding software to generate the application), and/or a player of the video game application (e.g., interacting with the video game application and/or one or more NPCs therein), among other examples. For instance, the player may manipulate an application state or environment of the video game application using natural language input according to aspects described herein.

It will be appreciated that a prompt need not be restricted to linguistic priming and may alternatively or additionally include mannerisms, actions, or states (e.g., as may be defined linguistically and/or programmatically), among other examples. In a further example, a prompt may include code or other programmatic definitions associated with dynamically accessing one or more variables or other aspects of the video game application.

In some instances, a first part of the prompt may define a general persona for the conversational agent, while a second scenario-specific part may define more specific aspects (e.g., as may be associated with scenarios such as a scene, locale, map, or specific storyline). In such instances, the first part may be used to generate model output for the conversational agent in multiple scenarios, while which scenario-specific part is used as the second part may vary based on scenario. For example, as a character transitions from one scenario to another in a video game application, the prompt may be updated to substitute a first scenario-specific part with a second scenario-specific part (e.g., while maintaining the same general persona part). In some instances, such a transition may similarly cause an associated context to be truncated, abridged, or reset.

Similarly, a context associated with a conversational agent may be maintained across multiple such scenarios, thereby enabling user interactions with the conversational agent to utilize knowledge of past interactions. For example, such aspects may be used when an NPC is present at in multiple scenarios of a story. In such examples, part of a past context may be used as a future prompt.

Accordingly, the behavior of the NPC may be controlled according to model output generated by a machine learning model. The model output may include natural language output, programmatic output (e.g., to affect conversational agent movement), audio output and/or intonation output (e.g., to affect speech of the conversation agent), image output (e.g., to affect an associated texture), and/or video output (e.g., to affect an associated animation), among other examples. It will be appreciated that a single multimodal machine learning model need not be used to generate all of these and other content types. Rather, a set of such multimodal machine learning models may be used, where each machine learning model may have at least a partially overlapping set of associated content types.

As an example, in instances where model output is used to control various visual and/or auditory aspects of an NPC (e.g., animations, facial expressions, intonation, etc.), the associated machine learning model may have been trained according to video training data in which movement of a subject of the video is annotated according to a skeletal model and dialogue is annotated according to an associated intonation, both of which may further be associated with the natural language meaning of the dialogue.

As a result of defining such aspects of a conversational agent using a prompt (and, in some examples, associated context), it may be possible to efficiently generate multiple conversational agents, for example each having different attitudes, roles, objectives, and/or mannerisms, even though the same multimodal machine learning model may be used for each of the conversational agents.

It will be appreciated that aspects of the present application need not be limited to user interactions with an application of a computing device. For example, similar techniques may be applied to user interaction with any of a variety of other devices, such as virtual assistants, smart home devices, robots, and/or animatronic devices, among other examples.

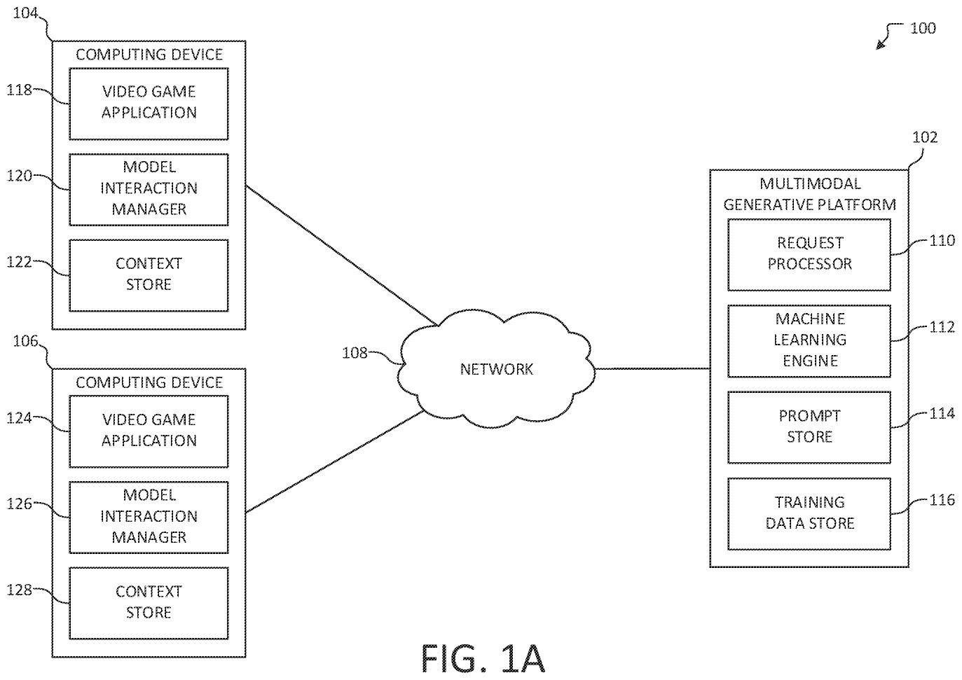

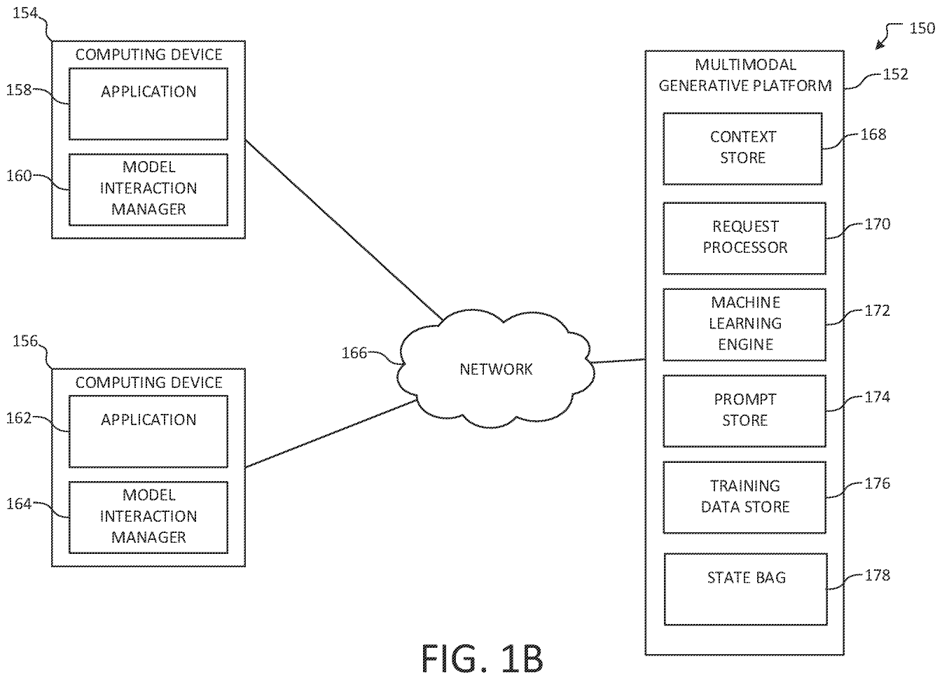

FIG. 1A illustrates an overview of an example system 100 for grounded multimodal agent interactions according to aspects described herein. As illustrated, system 100 comprises multimodal generative platform 102, computing device 104, computing device 106, and network 108. In examples, multimodal generative platform 102, computing device 104, and/or computing device 106 communicate via network 108, which may comprise a local area network, a wireless network, or the Internet, or any combination thereof, among other examples.

While system 100 is described in an example where processing is performed using a machine learning model that is remote to computing devices 104 and 106 (e.g., at multimodal generative platform 102), it will be appreciated that, in other examples, at least some aspects described herein with respect to a multimodal generative platform may be performed locally to computing device 104 and/or computing device 106.

Multimodal generative platform 102 is illustrated as comprising request processor 110, machine learning engine 112, prompt store 114, and training data store 116. In examples, request processor 110 receives a request from computing device 104 and/or computing device 106 (e.g., from model interaction manager 120 and model interaction manager 126, respectively) to generate model output (e.g., as may be generated by machine learning engine 112). For example, the request may include an indication of user input and/or a prompt or context, among other examples. In some instances, the request includes an indication of a prompt stored by prompt store 114 or, as another example, model interaction manager 120 may request a prompt from prompt store 114, which may subsequently be provided in a request to generate model output.

Machine learning engine 112 may comprise a multimodal machine learning model according to aspects described herein. For example, machine learning engine 112 may include a multimodal machine learning model that was trained using a training data set having a plurality of content types (e.g., associated with one or more types of user input that may be received from computing device 104 and/or 106, as well as one or more types of model output to be generated in response). Thus, given content of a first type, machine learning engine 112 may generate content of the first type and/or content of the second type.

Multimodal generative platform 102 is further illustrated as comprising prompt store 114, which may facilitate distribution of prompts with which model output may be generated according to aspects described herein. For example, a prompt stored by prompt store 114 may have an associated version, such that prompts used by computing device 104 and/or computing device 106 may be updated accordingly. In other instances, prompt store 114 stores a prompt (and, in some examples, an associated context) in association with a specific user or group of users (e.g., of computing device 104 and/or computing device 106), or a given application (e.g., video game application 118 and/or video game application 124), among other examples.

Training data store 116 may store training data associated with machine learning engine 112. In examples, training data store 116 is updated based on instances when it is determined that model output of machine learning engine 112 is inadequate (e.g., based on an associated confidence level or an indication received from model interaction manager 120 and/or model interaction manager 126, among other examples), such that machine learning engine 112 may subsequently be retrained to improve its performance.

As illustrated, computing device 104 includes video game application 118, model interaction manager 120, and context store 122. Similarly, computing device 106 includes video game application 124, model interaction manager 126, and context store 128. Aspects are described below with reference to computing device 104. However, computing device 106 may be similar to computing device 104, and, as such, aspects of computing device 106 are not necessarily re-described below in detail.

In examples, video game application 118 may be a native application or a web-based application. As another example, video game application 118 may operate substantially locally to computing device 104 or may operate according to a server/client paradigm in conjunction with one or more game servers (not pictured).

Video game application 118 may implement one or more conversational agents according to aspects described herein. For example, such conversational agents may be implemented as NPCs, virtual assistants, or as functionality of video game application 118 that enables model output-based control of video game application 118 in response to received user input. It will be appreciated that, in other examples, aspects of video game application 118 (as well as model interaction manager 120 and/or context store 122, in some examples) need not be local to computing device 104 and may instead by implemented remotely, for example by one or more game servers (not pictured).

Accordingly, model interaction manager 120 may process received user input to facilitate the generation of model output according to aspects described herein. For example, model interaction manager 120 may determine a prompt with which the received user input can be processed (e.g., as may be associated with a conversational agent of video game application 118), such that an indication of the determined prompt and the user input is provided to multimodal generative platform 102 (e.g., where it is received by request processor 110 and processed by machine learning engine 112 to generate model output). In response, model interaction manager 120 receives generated model output. In examples, at least a part of the user input and/or generated model output may be stored in context store 122 as context (e.g., in association with the conversational agent for which the user input was received), such that the context may be used in subsequent requests for model output from multimodal generative platform 102.

Model interaction manager 120 may process the model output to affect the behavior of video game application 118 according to aspects described herein. For example, the model output may include any of a variety of types of content, each of which may affect certain aspects of video game application 118. As an example, the model output may include programmatic output, which may be executed, parsed, or otherwise processed by model interaction manager 120 (e.g., as one or more API calls or function calls). As another example, the model output may include natural language output, which may be presented to a user of computing device 104 (e.g., as dialog of an NPC, as an alert or message, or as content of video game application 118).

As noted above, the model output may control any of a variety of other aspects of video game application 118, for example relating to textures, animations, and/or the intonation of spoken dialog, as well as mannerism, actions, poses, and/or states of an NPC. Thus, while example processing and associated content types are described, it will be appreciated that model interaction manager 120 may use any of a variety of techniques to process multimodal model output according to aspects of the present disclosure.

In some instances, model interaction manager 120 may determine that the model output is inadequate, as may be the case when the model output has an associated confidence level that is below a predetermined threshold, an indication of an error or other issue is received from multimodal generative platform 102 in addition to or as an alternative to the model output, or processing of at least a part of the model output fails (e.g., as may be the case when the model output includes code or other output that is syntactically or semantically incorrect), among other examples. In such instances, model interaction manager 120 may provide a failure indication to the user, for example indicating that the user may retry or reformulate the user input, that the user input was not correctly understood, or that the requested functionality may not be available. While example issues and associated issue handling techniques are described, it will be appreciated that any of a variety of other issues and/or issue handling techniques may be encountered/used in other examples.

As noted above, the same machine learning model (e.g., machine learning engine 112) may be used to control or otherwise provide multiple NPCs or virtual assistants, each of which may have a different associated persona (by virtue of an associated prompt, as discussed above). In such examples, model interaction manager 120 may determine a different prompt for each NPC or virtual assistant. Further, at least a part of the prompt may change depending on the state of video game application 118 (e.g., as a user progresses through a story, depending on a map, as a user increases a level associated with the user's account, etc.).

System 100 is illustrated as having computing device 104 and computing device 106 to illustrate that machine learning engine 112 may be used by multiple computing devices to generate any of a variety of model outputs associated with video game application 118 and video game application 124, respectively. In examples, prompts and/or context used by model interaction managers 120 and 126 may be different or may be similar (e.g., as may be the case when context is shared among a set of users or computing devices 104 and 106 share the same user). In other examples, multimodal generative platform 102 may have a context store in which conversational agent context may be stored.

In some instances, multimodal generative platform 102 may include multiple machine learning engines, for example associated with different video game applications (e.g., as may be the case when a machine learning engine has been fine-tuned for a given scenario), such that request processor 110 may determine a machine learning engine with which to process a request received from model interaction manager 120 and/or model interaction manager 126. Further, while aspects are described with respect to generating model output using a single multimodal generative machine learning model, it will be appreciated that, in other examples, multiple such models may be used. For example, a first multimodal generative machine learning model may have an associated first set of content types, while a second multimodal generative machine learning model may have an associated second set of content types, at least some of which may be different from the first set of content types.

FIG. 1B illustrates an overview of an example system 150 for grounded multimodal agent interactions according to aspects described herein. As illustrated, system 150 comprises multimodal generative platform 152, computing device 154, computing device 156, and network 166. In examples, multimodal generative platform 152, computing device 154, and/or computing device 156 communicate via network 166, which may comprise a local area network, a wireless network, or the Internet, or any combination thereof, among other examples. While a specific number of computing devices and platforms are depicted in exemplary system 150, one of skill in the art will appreciate that more or fewer devices and platforms may be utilized without departing from the scope of this disclosure.

While system 150 is described in an example where processing is performed using a machine learning model that is remote to computing devices 154 and 156 (e.g., at multimodal generative platform 152), it will further be appreciated that, in other examples, at least some aspects described herein with respect to a multimodal generative platform may be performed locally to computing device 154 and/or computing device 156.

Multimodal generative platform 152 is illustrated as comprising context store 168, request processor 170, machine learning engine 172, prompt store 174, training data store 176, and state bag 178. In examples, multimodal generative platform 152 may have a context store in which context associated with a virtual environment may be stored. Example virtual environments include, but are not limited to, a video game environment, a virtual collaboration environment, an alternate reality (AR) environment, and/or a virtual reality (VR) environment. For example, the virtual environment may be part of a metaverse. Content of the virtual environment may include environmental assets (e.g., sounds, textual overlays, two-dimensional (2D) or three-dimensional (3D) models or game objects, scenery, weapons, non-player characters (NPCs), and player models) and environmental mechanics (e.g., relating to the behavior of a given asset, a minigame, and/or set of choices for a role-playing game). The context stored in the context store may include complex language features which are applicable generally across the range of user inputs which the request processor 170 may receive such as colloquialisms, unstructured conversation streams, loops, conditionals, data structures, semantics, intent, misspelled natural language words, etc. For example, the model interaction manager 160 may send a user input to “make a block”. The user input may be received by the request processor 170, which may process the user input as an indication of a prompt stored by the prompt store as lines of code to make a three-dimensional block, which may be subsequently provided to prime the machine learning engine 172 to generate model output. In another instance, the model interaction manager 160 may send a user input to “make a blok”. The user input may be received by the request processor 170, which may process the user input as an indication of a prompt stored by the prompt store and it may also be an indication of a general context instance to resolve the misspelling “blok” with possible semantic options. In such an instance, the request processor 170 may utilize semantic context to resolve the misspelling as “block” and provide a prompt to generate model output as lines of code to make a three-dimensional block, similar to the previous example which was absent misspelling.

In examples, request processor 170 receives a user input from computing device 154 and/or computing device 156 (e.g., from model interaction manager 160 and model interaction manager 164, respectively) to generate model output (e.g., as may be generated by machine learning engine 172). For example, the request may include an indication of user input and/or a prompt or context, among other examples. In some instances, the request includes an indication of a prompt stored by prompt store 174 or, as another example, model interaction manager 160 may request a prompt from prompt store 174, which may subsequently be provided as input to generate model output. In another instance, the request includes an indication of a prompt stored by prompt store 174 as well as an indication of an object referenced to the context store 168. The referenced object may be a previously output object, such as “a ball”, that is referred to in the request as “make it red”. Machine learning engine 172 may reference the context store 168 to determine the context required to complete the request, combine the context with the stored prompt, and subsequently generate model output.

Machine learning engine 172 may comprise a multimodal machine learning model according to aspects described herein. For example, machine learning engine 172 may include a multimodal machine learning model that was trained using a training data set having a plurality of content types (e.g., associated with one or more types of user input that may be received from computing device 154 and/or 156, as well as one or more types of model output to be generated in response). Thus, given content of a first type, machine learning engine 172 may generate content of the first type and/or content of the second type.

One or more prompts may be utilized to prime the machine learning engine 172 to generate new programmatic code as a model output. The model output may be new and/or distinct from the associated programmatic code provided in the prompt. The machine learning engine 172 may produce new programmatic code as model output, rather than copying previous programmatic code. Additionally, the prompt may contain one or more examples of APIs that may be subsequently used to generate model output. For example, the user input may be natural language command “Make a cube”. An applicable prompt may be the comment “/* Make a cube */” and associated programmatic code may be “state.cube=BABYLON.MeshBuilder.CreateBox(“cube”, {size: 100}, scene);” which would be input to a machine learning engine 172 to prime it to generate similar but new programmatic code as a model output. The model output may be new programmatic code “state. cube=BABYLON.MeshBuilder.CreateBox(“cube”, {size: 1}, scene);” which though similar, is new and/or distinct from the associated programmatic code in the prompt.

While an example prompt is provided in which the comment and associated programmatic code are similar to the natural language input, it will be appreciated that, in other examples, a prompt may be dissimilar from a received natural language input. For example, a prompt may prime the multimodal machine learning model to effectively understand syntactical aspects and/or naming conventions associated with an API, among other examples.

Prompts may also be provided to the machine learning engine to generate abstract objects from library primitives. Examples of library primitives in BabylonJS include, but are not limited to, cubes, spheres, and torusses. A library primitive may be referenced in a user input as a command to create an abstract shape out of the library primitives as the model output from the machine learning engine 172. This provides the benefit of demonstrating to the machine learning engine 172 that it may take creative liberties from the direction provided in the user input when generating new programmatic code as described herein. For example, a user input may be provided to “make a tornado out of torusses”. The machine learning engine 172 may not have sample code showing how to make a tornado. As such, the machine learning engine 172 would have the opportunity to create new programmatic code of what it considers to be an accurate representation of a “tornado of torusses” as model output. In such an instance, the model output may include this code: /* Make a tornado out of torusses */

state.tornado = [ ];
for (let i = 0; i < 50; i++) {
state.tornado[i] = BABYLON.MeshBuilder.CreateTorus(“tornado”,
{diameter: i, thicknes
s: 0.1}, scene);
state.tornado[i].position.y = i;
}.

Multimodal generative platform 152 is further illustrated as comprising prompt store 174, which may facilitate distribution of prompts with which model output may be generated according to aspects described herein. A prompt may be an example of a type of model input, such as a text comment, coupled with an associated programmatic code segment similar to the expected model output from a machine learning engine (e.g., machine learning engine 172). A prompt may be designed as a comment because the programmatic code utilized by the machine learning engine 170 may recognize that a comment is a description of the programmatic code which follows it.

Prompt store 174 may include one or more libraries. In the present examples, a library may be a scripting language or other framework for building or manipulating a virtual environment using programmatic code. It will be appreciated that the disclosed aspects may be applied in any of a variety of other contexts and, for example, need not rely on a library to control an application and/or associated content. A library may contain sample programmatic code for meshes, textures, materials, post-processing, and/or procedurally generated textures, among other examples. A multimodal model may thus be utilized to translate the user input into programmatic code according to aspects described herein. The translated programmatic code may be in a common programmatic coding language such as JavaScript, Python, Go, Perl, PHP, Ruby, Swift, TypeScript, and/or SQL among other examples. The initial programmatic code that is generated in response to the user input may establish the asset library from which sample code for assets may be referenced. For example, the natural language comment “/* Make a cube */” may be translated into the programmatic code “state.cube=BABYLON.MeshBuilder.CreateBox(“cube”, {size: 1}, scene);” which establishes BabylonJS as the asset library.

Training data store 176 may store or aggregate training data associated with machine learning engine 172. In examples, training data store 176 is updated based on instances when it is determined that model output of machine learning engine 172 is inadequate (e.g., based on an associated confidence level or an indication received from model interaction manager 160 and/or model interaction manager 166, among other examples), such that machine learning engine 172 may subsequently be retrained to improve its performance.

The state bag (e.g., state bag 178) may be an empty object state bag of the utilized programmatic coding language (e.g., a JSON object state bag for JavaScript). The state bag may be a location to store objects of programmatic code generated by the machine learning engine (e.g., machine learning engine 172) as part of the model output. Objects may be named and placed in the state bag for reference as a point back when generating new programmatic code based on a second user input that includes a reference to the object in the state bag. Over multiple iterations of user input and model output, multiple objects may be referenced and/or stored in the state bag along with, in some examples, the command interaction that led to the output and utilized by the machine learning engine. Additionally, over multiple iterations objects stored in the state bag may be updated, created, deleted, and/or canceled, relationships may be created between the objects, and/or behaviors may be established that modify the objects.

For example, in the model output of machine learning engine 172, may contain a “cube” object. The “cube” object may be stored in the state bag for reference later by the request processor 170. Over multiple iterations, the “cube” may be output multiple times as a “teal cube” or as a “spinning teal cube” based on the user inputs. In such instances, the “cube” object previously stored in the state bag 178 may be updated with the new code from the appropriate model output which references the state of the cube. In such instances, if a further iteration of the “cube” was obtained from the state bag 178, the programmatic code that the subsequent prompt would be appended to may be the updated code referencing the new state of the “cube” object. Further, as the programmatic code of the object within the state bag is updated, the previously saved code may be deleted or updated.

As illustrated, computing device 154 includes application 158 and model interaction manager 160. Similarly, computing device 156 includes application 162 and model interaction manager 164. Aspects are described below with reference to computing device 154. However, computing device 156 may be similar to computing device 154, and, as such, aspects of computing device 156 are not necessarily re-described below in detail.

In examples, application 158 may be a native application or a web-based application. As another example, application 158 may operate substantially locally to computing device 154 or may operate according to a server/client paradigm in conjunction with one or more game servers (not pictured).

Application 158 may implement or otherwise provide a virtual environment. For example, such a virtual environment may be implemented as functionality of application 158 that executes code that enables model output to be used to adapt the behavior of application 158 and/or an associated virtual environment in response to received user input. The adapted behavior may be the display of a three-dimensional object and/or various actions associated with the three-dimensional object. It will be appreciated that, in other examples, aspects of application 158 (as well as model interaction manager 160 in some examples) need not be local to computing device 154 and may instead by implemented remotely, for example by one or more servers (not pictured).

Accordingly, model interaction manager 160 may process received user input to facilitate the generation of model output according to aspects described herein. For example, model interaction manager 160 may provide the user input to the request processor which may subsequently determine a prompt and/or context with which the received user input may be processed by the machine learning engine 172 which may generate model output. such that an The model interaction manager 160 may receive generated model output for use in the virtual environment on application 158. In examples, at least a part of the user input and/or generated model output may be stored in as an object in the state bag 178 (e.g., in association with the conversational agent for which the user input was received), such that the state bag 178 may be referenced in subsequent requests for model output.

Model interaction manager 160 may execute the model output to affect the behavior of application 158 according to aspects described herein. For example, the model output may include any of a variety of types of content, each of which may affect certain aspects of application 118. As an example, the model output may include programmatic output, such as lines of code that produce three dimensional objects, which may be executed, parsed, or otherwise processed by model interaction manager 160 (e.g., as one or more API calls or function calls). As another example, the model output may include natural language output, which may be presented to a user of computing device 154.

As noted above, the model output may control any of a variety of other aspects of application 158, for example relating to textures, animations, two-dimensional renderings, and/or three-dimensional renderings, as well as mannerism, actions, poses, and/or states of an object. Thus, while example processing and associated content types are described, it will be appreciated that model interaction manager 160 may use any of a variety of techniques to process multimodal model output according to aspects of the present disclosure.

In some instances, model interaction manager 160 may determine that the model output is inadequate, as may be the case when the model output has an associated confidence level that is below a predetermined threshold, an indication of an error or other issue is received from multimodal generative platform 152 in addition to or as an alternative to the model output, or processing of at least a part of the model output fails (e.g., as may be the case when the model output includes code or other output that is syntactically or semantically incorrect), among other examples. In such instances, model interaction manager 160 may provide a failure indication to the user, for example indicating that the user may retry or reformulate the user input, that the user input was not correctly understood, or that the requested functionality may not be available. While example issues and associated issue handling techniques are described, it will be appreciated that any of a variety of other issues and/or issue handling techniques may be encountered/used in other examples.

As noted above, the same machine learning model (e.g., machine learning engine 172) may be used to control or otherwise provide multiple forms of output (e.g., two dimensional renderings, three dimensional renderings, NPCs or virtual assistants, etc.) each of which may have a different associated context (by virtue of an associated prompt or associated context, as discussed above). In such examples, model interaction manager 160 may determine a different prompt for different forms of output. Further, at least a part of the prompt may change depending on the state of application 158.

System 150 is illustrated as having computing device 154 and computing device 156 to illustrate that machine learning engine 172 may be used by multiple computing devices to generate any of a variety of model outputs associated with application 158 and application 162, respectively. In examples, prompts and/or context used by model interaction managers 160 and 164 may be different or may be similar (e.g., as may be the case when context is shared among a set of users or computing devices 154 and 156 share the same user). In other examples, computing devices 154 and 156 may each have a context store in which associated context may be stored.

In some instances, multimodal generative platform 152 may include multiple machine learning engines, for example associated with different applications (e.g., as may be the case when a machine learning engine has been fine-tuned for a given virtual environment, modeling application, and/or other scenario), such that request processor 170 may determine a machine learning engine with which to process a request received from model interaction manager 160 and/or model interaction manager 164. Further, while aspects are described with respect to generating model output using a single multimodal generative machine learning model, it will be appreciated that, in other examples, multiple models may be used. For example, a first multimodal generative machine learning model may have an associated first set of content types, while a second multimodal generative machine learning model may have an associated second set of content types, at least some of which may be different from the first set of content types.

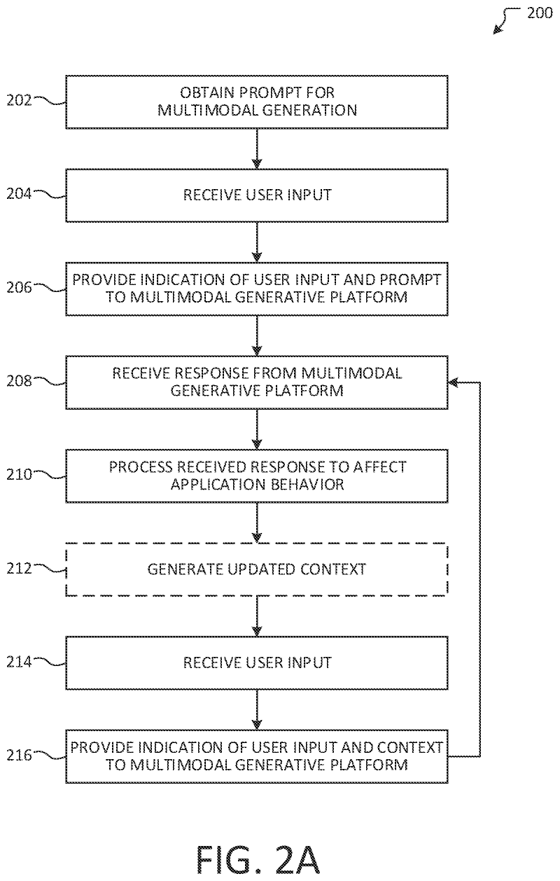

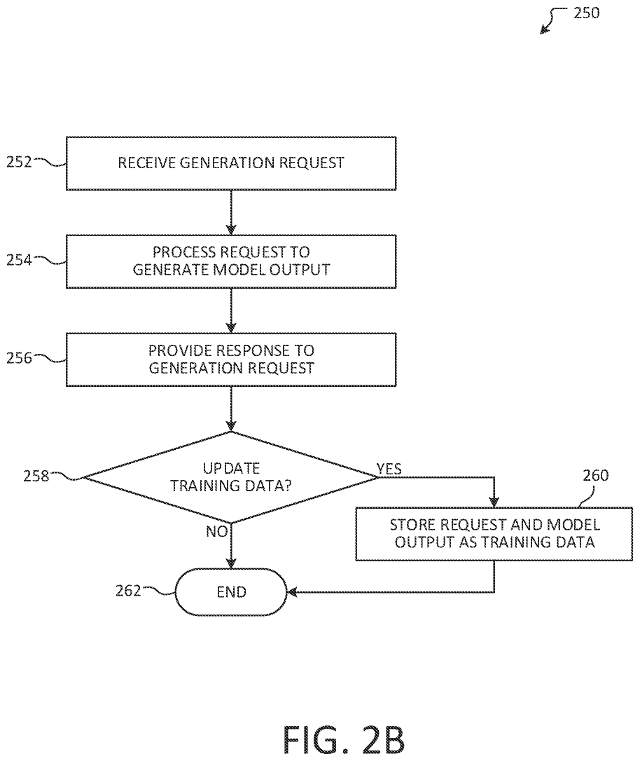

FIG. 2A illustrates an overview of an example method 200 for affecting an application based on model output from a multimodal machine learning model according to aspects described herein. In examples, aspects of method 200 are performed by a model interaction manager, such as model interaction manager 120 or model interaction manager 126 discussed above with respect to FIG. 1A.

Method 200 begins at operation 202, where a prompt is obtained for multimodal generation. For example, the prompt may be obtained from a prompt store of a multimodal generative platform (e.g., prompt store 114 of multimodal generative platform 102). As another example, an application may be distributed with a set of prompts from which the prompt may be obtained. In a further example, at least a part of the prompt may be user-provided, for example as may be the case when a user is creating or revising a prompt for use with a given application. Thus, it will be appreciated that a prompt may be obtained according to any of a variety of techniques.

At operation 204, user input is received. Example user inputs include, but are not limited to, natural language input (e.g., textual input or spoken input), programmatic input, and/or gestural input, among any of a variety of other interactions with an application. In some instances, the received user input may be multimodal, for example including multiple content types.

Flow progresses to operation 206, where an indication of the user input and the prompt are provided to a multimodal generative platform (e.g., multimodal generative platform 102). In examples, the received user input may be processed prior to providing it to the multimodal generative platform, for example to perform automated speech recognition or to perform gesture recognition. In other examples, such processing may instead be performed by the multimodal generative platform.

Moving to operation 208, a response is received from the multimodal generative platform. In examples, the response comprises model output that was generated by a machine learning engine (e.g., machine learning engine 112). In some instances, the model output may itself be multimodal or at least a part of it may have a different associated content type than the user input that was provided at operation 206. In other instances, at least a part of the model output may have the same content type as the provided user input.

At operation 210, the response is processed to affect application behavior accordingly. In examples, the processing performed at operation 210 depends on a content type of the model output. For example, if the model output includes natural language output, the natural language output may be presented to the user (e.g., as text or as spoken dialogue). As another example, if the model output includes programmatic output, the programmatic output may be parsed or otherwise executed. In some instances, the model output includes multiple content types, such that operation 210 includes identifying multiple subparts therein and processing each subpart accordingly. In other instances, the model output may be programmatic output in which natural language output is encapsulated, such that executing, parsing, or otherwise processing the programmatic output will result in presentation of the natural language output to the user. While method 200 is described using the example of natural language output and/or programmatic output, it will be appreciated that similar techniques may be applied to any of a variety of content types.

In some instances, operation 210 may comprise determining that the model output is inadequate and handling such an identified issue accordingly. As discussed above, a failure indication may be presented to the user, for example indicating that the user may retry or reformulate the user input, that the user input was not correctly understood, or that the requested functionality may not be available. While example issues and associated issue handling techniques are described, it will be appreciated that any of a variety of other issues and/or issue handling techniques may be encountered/used in other examples.

Flow progresses to operation 212, where an updated context is generated. For example, the context may be updated in a context store, such as context store 122 or context store 128 discussed above with respect to FIG. 1A. The updated context may include the prompt obtained at operation 202, the user input that was received at operation 204, and/or the response that was received at operation 208, among other examples. As discussed above, a context may maintain only a part of previous conversational agent interactions, such that later interactions (e.g., beyond a predetermined number of interactions or after a predetermined time) may be omitted. Operation 212 is illustrated using a dashed box to indicate that, in some examples, operation 212 may be omitted. For instance, a context may not be maintained, such that subsequent conversational agent interactions similarly utilize the prompt that was obtained at operation 202.

Eventually, flow progresses to operation 214, where subsequent user input is received. Accordingly, an indication of the received user input and context (or, in instances where a context is not maintained, the prompt obtained at operation 202) is provided to the multimodal generative platform. Aspects of operations 214 and 216 are similar to those discussed above with respect to operations 204 and 206, and are therefore not necessarily re-described in detail. In the described examples, the machine learning engine may not maintain a state associated with operations of method 200. Rather, any such state may be maintained by virtue of the context generated at operation 212 and/or the prompt that was obtained at operation 202. Thus, usage of the machine learning engine to generate associated model output may be said to be “zero-shot” in some examples.

Flow returns to operation 208, where a response is received from the multimodal generative platform based on the provided user input, such that it may be processed at operations 210 and 212 accordingly. Thus, flow may loop between operations 208-216 to process user input and enable conversational agent interactions using a multimodal machine learning model according to aspects described herein.

FIG. 2B illustrates an overview of an example method 250 for generating a multimodal response according to aspects described herein. In examples, aspects of method 250 are performed by a multimodal generative platform, such as multimodal generative platform 102 discussed above with respect to FIG. 1A.

As illustrated, method 250 begins at operation 252, where a generation request is received. For example, the request may be received from a model interaction manager, such as model interaction manager 120 or model interaction manager 126 discussed above with respect to FIG. 1A. In examples, the request is received as a result of performing aspects of operation 206 or operation 216 discussed above with respect to method 200 in FIG. 2A. The request may include an indication of user input, as well as a prompt and/or context.

At operation 254, the request is processed to generate model output. For example, the request may be processed using a multimodal machine learning model of a machine learning engine, such as machine learning engine 112. In examples, processing the request comprises determining a machine learning model from a set of machine learning models, as may be the case when an application from which the request was received at operation 252 is associated with a specific machine learning model.

Flow progresses to operation 256, where a response is provided to the request that was received at operation 252. For example, the request may include the model output that was generated at operation 254. In some examples, the response may additionally or alternatively include a confidence level associated with the model output or an indication that the model output is inadequate.

At determination 258, it is determined whether to update training data associated with the machine learning engine. For example, the determination may comprise evaluating a confidence level associated with the model output that was generated at operation 254. In other examples, an indication may be received from a model interaction manager. Thus, it will be appreciated that it may be determined to update training data in any of a variety of scenarios.

Accordingly, if it is determined to update the training data, flow branches “YES” to operation 260, where at least a part of the request that was received at operation 252 is stored as training data in association with the generated model output. For example, the training data may be stored in a training data store, such as training data store 116 discussed above with respect to FIG. 1A. As a result, the machine learning engine may be retrained using the training data, thereby improving model performance in the future. Flow then terminates at operation 262. Similarly, if it is instead determined not to update the training data, flow branches “NO” and also terminates at operation 262.

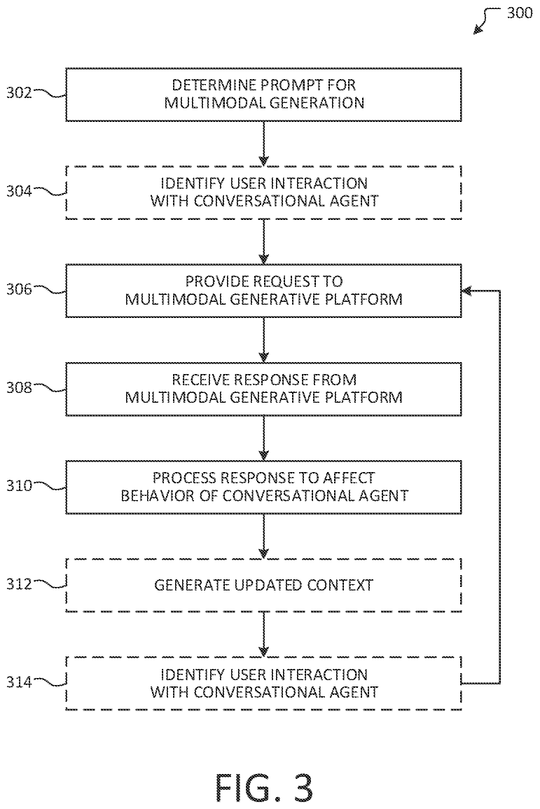

FIG. 3 illustrates an overview of an example method 300 for controlling a conversational agent using a multimodal generative platform according to aspects described herein. In examples, aspects of method 300 are performed by a model interaction manager (e.g., model interaction manager 120 or model interaction manager 126 in FIG. 1A) to affect behavior of a video game application (e.g., video game application 118 or video game application 124).

In the context of a video game application, the conversational agent may be an NPC, for example having a visual representation that is presented to a user. As another example, the conversational agent may be a virtual assistant or a narrator, which may not have an associated visual representation. While example conversational agents are described, it will be appreciated that any of a variety of other conversational agents may be used in other examples.

Method 300 begins at operation 302, where a prompt is determined for multimodal generation. For example, the prompt may be obtained from a prompt store of a multimodal generative platform (e.g., prompt store 114 of multimodal generative platform 102) or a game server, among other examples. As another example, the video game application may be distributed with a set of prompts from which the prompt may be obtained. In a further example, at least a part of the prompt may be user-provided, for example as may be the case when a user is creating or revising a prompt for use with the video game application.

As noted above, a prompt may have multiple parts, where a first part of the prompt defines a general persona for the conversational agent, while a second part defines more specific aspects (e.g., as may be associated with a scene, locale, map, or specific storyline). In such instances, operation 304 may comprise generating a prompt having a general part and one or more scenario-specific parts, where the scenario-specific parts are selected from a set of scenario-specific parts. In some instances, the set of scenario-specific prompts may be associated with the general part of the prompt, for example such that each different prompt may have a different associated set of scenario-specific parts. In other instances, the set of scenario-specific prompts may be used in association with multiple prompts, as may be the case when multiple NPCs each have a different general persona and but are intended to have similar scenario-specific parameters for the same scenario. Thus, it will be appreciated that a prompt may be determined according to any of a variety of techniques.

At operation 304, a user interaction associated with the conversational agent is identified. Example user interactions include, but are not limited to, natural language input (e.g., textual input or spoken input, as may be specifically directed to the conversational agent or more generally provided by a user), input associated with a player avatar, gestural input, mouse input, and/or keyboard input, among any of a variety of other interactions. In some instances, the identified user interaction may be multimodal, for example including both natural language input and player avatar input.

Operation 304 is illustrated using a dashed box to indicate that, in some examples, operation 304 may be omitted. For example, behavior of the conversational agent may be controlled according to method 300 even in instances where user interactions are not received. In some examples, aspects of operation 300 may be performed as a result of a conversational agent becoming visible to a user, in response to the occurrence of an event within the video game application, and/or after a predetermined amount of time has elapsed. Thus, it will be appreciated that any of a variety of triggers maybe used and, further, such triggers need not be directly related to a user interaction with the video game application.

Flow progresses to operation 306, where a request is provided to a multimodal generative platform (e.g., multimodal generative platform 102). In examples, the request includes the prompt that was determined at operation 302 and, in instances where user interaction is identified, an indication of the identified user interaction. In examples, the user interaction may be processed prior to providing it to the multimodal generative platform, for example to perform automated speech recognition or to perform gesture recognition. In other examples, such processing may instead be performed by the multimodal generative platform.

Moving to operation 308, a response is received from the multimodal generative platform. In examples, the response comprises model output that was generated by a machine learning engine (e.g., machine learning engine 112). In some instances, the model output may itself be multimodal or at least a part of it may have a different associated content type than the prompt and/or indication of a user interaction that was provided at operation 306. In other instances, at least a part of the model output may have the same content type as what was provided at operation 306.

At operation 310, the response is processed to control the behavior of the conversational agent accordingly. In examples, the processing performed at operation 310 depends on a content type of the received model output. For example, if the model output includes natural language output, the natural language output may be presented to the user (e.g., as text or as spoken dialogue). As another example, if the model output includes programmatic output, the programmatic output may be parsed or otherwise executed to affect the appearance and/or behavior of the conversational agent within the video game application. In some instances, the model output includes multiple content types, such that operation 310 includes identifying multiple subparts therein and processing each subpart accordingly. In other instances, the model output may be programmatic output in which natural language output is encapsulated, such that executing, parsing, or otherwise processing the programmatic output will result in presentation of the natural language output to the user.

While method 300 is described using the example of natural language output and/or programmatic output, it will be appreciated that similar techniques may be applied to any of a variety of content types. For example, model output received at operation 308 may include textures, animations (e.g., avatar animations or facial animations), intonation information for spoken dialogue, sound effects, or other content usable to affect the behavior of the conversational agent (e.g., textually, aurally, or visually) of the video game application.

In some instances, operation 310 may comprise determining that the model output is inadequate and handling such an identified issue accordingly. As discussed above, a failure indication may be presented to the user, for example indicating that the user may retry or reformulate a user interaction, that the user interaction was not correctly understood, or that the requested functionality may not be available (e.g., as may be the case when programmatic output is syntactically or semantically incorrect for a given video game application). While example issues and associated issue handling techniques are described, it will be appreciated that any of a variety of other issues and/or issue handling techniques may be encountered/used in other examples.

Flow progresses to operation 312, where an updated context is generated. For example, the context may be updated in a context store, such as context store 122 or context store 128 discussed above with respect to FIG. 1A. The updated context may include the prompt determined at operation 302, the user interaction that was identified at operation 304, and/or the response that was received at operation 308, among other examples. As discussed above, a context may maintain only a part of previous conversational agent interactions, such that later interactions (e.g., beyond a predetermined number of interactions or after a predetermined time) may be omitted. Operation 312 is illustrated using a dashed box to indicate that, in some examples, operation 312 may be omitted. For instance, a context may not be maintained, such that subsequent conversational agent interactions similarly utilize the prompt that was obtained at operation 302.

In the context of conversational agents of a video game application, certain conversational agents may establish a history with a user, such that the conversational agent has knowledge of previous interactions with the user. By contrast, other conversational agents may not have such history, as may be the case with one-off conversational agents or conversational agents that are recurring (and may therefore have different scenario-specific prompt parts in different scenarios) but need not have knowledge of past interactions.

Eventually, flow progresses to operation 314, where a subsequent user interaction is identified. Similar to operation 304, operation 314 is illustrated using a dashed box to indicate that, in other examples, a user interaction need not be identified. Aspects of operation 314 are similar to those discussed above with respect to operation 304 and are therefore not necessarily re-described in detail. For example, flow may progress to operation 306 as a result of any of a variety of other triggers. As illustrated, flow returns to operation 306, where a request is provided to the multimodal generative platform.

Thus, flow may loop between operations 306-314 to process user interactions and enable conversational agent interactions using a multimodal machine learning model according to aspects described herein (e.g., using a prompt and/or context, as may be maintained by operation 312). As noted above, aspects of method 300 may be provided for multiple conversational agents of a video game application, such that each conversational agent may exhibit at least slightly different behavior even though the same machine learning engine is used to generate the model output.

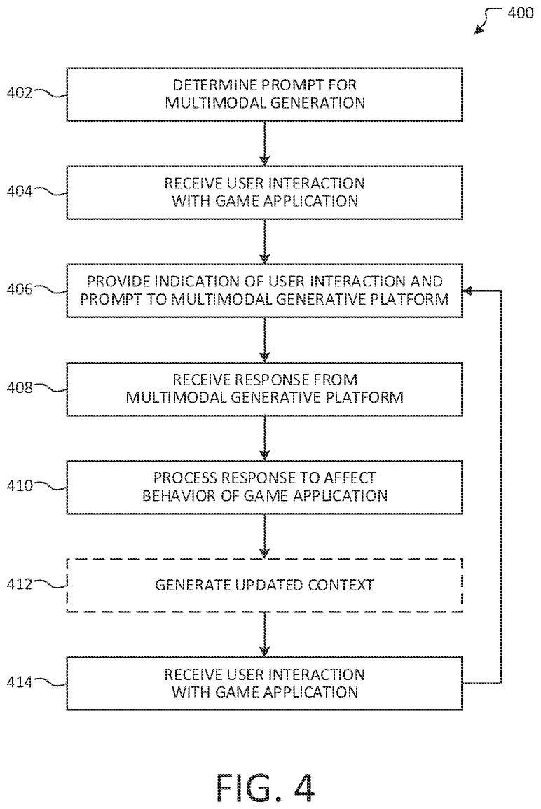

FIG. 4 illustrates an overview of an example method 400 for controlling a video game application using a multimodal generative platform according to aspects described herein. In examples, aspects of method 400 are performed by a model interaction manager (e.g., model interaction manager 120 or model interaction manager 126 in FIG. 1A) to affect behavior of a video game application (e.g., video game application 118 or video game application 124).

It will be appreciated that a video game application may provide any of a variety of controls, including, but not limited to, user interface elements, keyboard input, mouse input, controller input, gesture input, and/or voice input. Thus, in addition to such controls, aspects of method 400 may enable a user to access similar functionality via a multimodal machine learning model, for example using natural language input, where the resulting model output is processed according to aspects described herein to control the video game application as directed by the user.

Method 400 begins at operation 402, where a prompt is determined for multimodal generation. For example, the prompt may be obtained from a prompt store of a multimodal generative platform (e.g., prompt store 114 of multimodal generative platform 102) or a game server, among other examples. As another example, the video game application may be distributed with a set of prompts from which the prompt may be obtained. In a further example, at least a part of the prompt may be user-provided, for example as may be the case when a user is creating or revising a prompt for use with the video game application. In some instances, different prompts may be associated with different aspects of the video game application, as may be the case when different controls and/or functionality are available in different scenarios.

At operation 404, a user interaction with the video game application is received. Example user interactions include, but are not limited to, natural language input (e.g., textual input or spoken input), input associated with a player avatar, gestural input, mouse input, and/or keyboard input, among any of a variety of other interactions. In some instances, the received user input may be multimodal, for example including both natural language input and gestural input.

Flow progresses to operation 406, where an indication of the user input and the prompt are provided to a multimodal generative platform (e.g., multimodal generative platform 102). In examples, the received user input may be processed prior to providing it to the multimodal generative platform, for example to perform automated speech recognition or to perform gesture recognition. In other examples, such processing may instead be performed by the multimodal generative platform.

Moving to operation 408, a response is received from the multimodal generative platform. In examples, the response comprises model output that was generated by a machine learning engine (e.g., machine learning engine 112). In some instances, the model output may itself be multimodal or at least a part of it may have a different associated content type than the prompt and/or indication of user input that was provided at operation 406. In other instances, at least a part of the model output may have the same content type as what was provided at operation 406.

At operation 410, the response is processed to control the behavior of the video game application accordingly. In examples, the processing performed at operation 410 depends on a content type of the received model output. For example, if the model output includes natural language output, the natural language output may be presented to the user (e.g., as text or as spoken dialogue). As another example, if the model output includes programmatic output, the programmatic output may be parsed or otherwise executed to control functionality of the video game application. For example, the programmatic output may include one or more API calls, may identify one or more user interface elements for actuation, or may include executable code to achieve functionality similar to that of other controls offered by the video game application. In some instances, the model output includes multiple content types, such that operation 410 includes identifying multiple subparts therein and processing each subpart accordingly. In other instances, the model output may be programmatic output in which natural language output is encapsulated, such that executing, parsing, or otherwise processing the programmatic output will result in presentation of the natural language output to the user.

While method 400 is described using the example of natural language output and/or programmatic output, it will be appreciated that similar techniques may be applied to any of a variety of content types. For example, model output received at operation 408 may include macros, game objects, or other content usable to affect operation of the video game application responsive to the user interaction what was received at operation 404, other examples of which are discussed above. For example, a game object received at operation 408 may be processed and imported into an application state of the video game application, thereby enabling a user to create or, in other examples, manipulate game objects using natural language input (whereas arriving at a similar result using other, more traditional functionality may involve a high degree of manual interactions with various controls provided by the video game application).

In some instances, operation 410 may comprise determining that the model output is inadequate and handling such an identified issue accordingly. As discussed above, a failure indication may be presented to the user, for example indicating that the user may retry or reformulate a user interaction, that the user interaction was not correctly understood, or that the requested functionality may not be available (e.g., as may be the case when programmatic output is syntactically or semantically incorrect for a given video game application). While example issues and associated issue handling techniques are described, it will be appreciated that any of a variety of other issues and/or issue handling techniques may be encountered/used in other examples.

Flow progresses to operation 412, where an updated context is generated. For example, the context may be updated in a context store, such as context store 122 or context store 128 discussed above with respect to FIG. 1A. The updated context may include the prompt determined at operation 402, the user interaction that was received at operation 404, and/or the response that was received at operation 408, among other examples. As discussed above, a context may maintain only a part of previous conversational agent interactions, such that later interactions (e.g., beyond a predetermined number of interactions or after a predetermined time) may be omitted. Operation 412 is illustrated using a dashed box to indicate that, in some examples, operation 412 may be omitted. For instance, a context may not be maintained, such that subsequent conversational agent interactions similarly utilize the prompt that was obtained at operation 402.

Eventually, flow progresses to operation 414, where a subsequent user interaction is received. Aspects of operation 414 are similar to those discussed above with respect to operation 404 and are therefore not necessarily re-described in detail. As illustrated, flow returns to operation 406, where a request is provided to the multimodal generative platform. Thus, flow may loop between operations 406-414 to process user interactions to control game application functionality using a multimodal machine learning model according to aspects described herein (e.g., using a prompt and/or context, as may be maintained by operation 412).

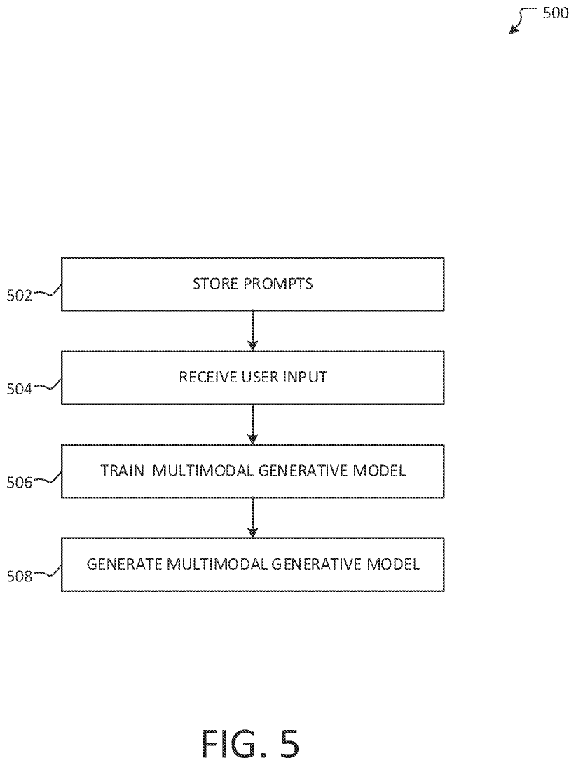

FIG. 5 illustrates an overview of an example method 500 for generating a trained multimodal generative model according to aspects described herein. In examples, aspects of method 500 are performed by a model interaction manager, such as model interaction manager 160 or model interaction manager 164 as well as other components discussed above with respect to FIG. 1B.

Method 500 begins at operation 502, where one or more prompts stored in the prompt store 174. For example, a prompt may be received as the basis for the future interaction with the request processor (e.g., request processor 170). As noted above, a prompt may be an example of a type of model input, such as a text comment, coupled with an associated programmatic code segment, among other examples.

Flow progresses to operation 504, where user input is received. As noted above, user input may be a natural language command that describes a three-dimensional scene which may be translated into code. Example user inputs include, but are not limited to, natural language input (e.g., textual input or spoken input), programmatic input, and/or gestural input, among any of a variety of other interactions with an application. In some instances, the received user input may be multimodal, for example including multiple content types. The user input may be received for example by the request processor (e.g., request processor 170).

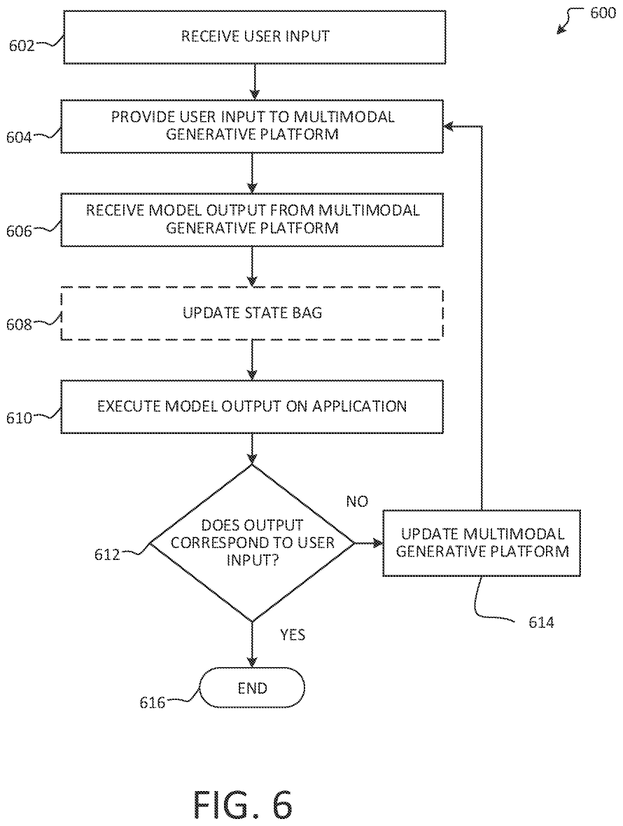

Flow progresses to operation 506, where the multimodal generative model is trained. For example, the request processor (e.g., request processor 170), having received user input, may access a prompt store (e.g., prompt store 174) and a state bag (e.g., state bag 178) to obtain applicable comments and programmatic code inputs to prime the machine learning engine (e.g., machine learning engine 172) which may generate new programmatic code as model output. The model output may be returned to the model interaction manager (e.g., model interaction manager 160) for execution by the application (e.g., application 158). The output may be evaluated by the user to determine if it matches the desired model output. Training data, prompts, and context may be updated based on the determination made for model output evaluation. Additional examples of such aspects are discussed below with respect to FIG. 6.

Flow progresses to operation 508, where a multimodal generative model is generated. Following training the multimodal generative model will be generated to produce multimodal model output, which, as used herein, may comprise one or more types of content. Example content includes, but is not limited to, written language (which may also be referred to herein as “natural language output”), code (which may also be referred to herein as “programmatic output”), images, video, audio, gestures, visual features, intonation, contour features, poses, styles, fonts, and/or transitions, among other examples. Thus, as compared to a machine learning model that processes natural language input and generates natural language output, aspects of the present disclosure may process input and generate output having any of a variety of content types. Flow then terminates at operation 508.

FIG. 6 illustrates an overview of an example method 600 for training a multimodal generative model according to aspects described herein. In examples, aspects of method 600 are performed by a model interaction manager, such as model interaction manager 160 or model interaction manager 164 as well as other components discussed above with respect to FIG. 1B.

Method 600 begins at operation 602, where user input is received. Example user inputs include, but are not limited to, natural language input (e.g., textual input or spoken input), programmatic input, and/or gestural input, among any of a variety of other interactions with an application. In some instances, the received user input may be multimodal, for example including multiple content types. The user input may be received or otherwise identified, for example, by model interaction manager 160 as discussed with respect to FIG. 1B.

Flow progresses to operation 604, where the user input is provided to the multimodal generative platform. The user input may be received by a request processor (e.g., request processor 170) from the model interaction manager (e.g., model interaction manager 160. For example, the user input may be associated with a library with which a virtual environment and/or an associated modeling application may be manipulated. In another instance, the user input may be a command to generate an abstract object from a reference object stored in a library, such as “Make a tornado out of torusses”.

Flow progresses to operation 606, where model output is received from the multimodal generative platform. The model output may be received by the model interaction manager (e.g., model interaction manager 160). In examples, the response may comprise model output that was generated by a machine learning engine (e.g., machine learning engine 172). In some instances, model output may be new programmatic code that, when executed by the application (e.g., application 158), may adapt a virtual environment. For example, a new object may be generated within the virtual environment, an existing object may be manipulated, or any of a variety of other content may be added, removed, or otherwise manipulated, among other examples.

Flow progresses to operation 608, where a state bag may be updated. In instances where the state bag (e.g., state bag 178) is maintained on the client side at the computing device (e.g., computing device 154), the state bag may be updated to store an object generated as part of the model output from operation 606. As noted above, the state bag (e.g., state bag 178) may be an empty object state bag of the utilized programmatic coding language and may be a location in which to store objects of programmatic code generated by the machine learning engine (e.g., machine learning engine 172) as part of the model output. As such, an object in the state bag may be referenced when generating new programmatic code (e.g., based on a second user input that includes a natural language reference to the programmatic object in the state bag). The operation 608 may be optional and for this reason is shown with a dashed box to indicate it is not a required step of the method. For instance, the state bag may be maintained at least in part by the multimodal generative platform (e.g., multimodal generative platform 152) and updated accordingly, following the machine learning engine (e.g., machine learning engine 172) generating model output.

Flow progresses to operation 610, where the model output is executed to produce or otherwise adapt a virtual environment. The new programmatic code may be executed on the application (e.g., application 158) to produce or otherwise adapt a virtual environment. In some instances, the virtual environment may include multiple objects, introduce new objects, modify existing objects, perform actions with objects in the scene and/or perform a myriad of other available actions. For example, taking the model output from operation 608, the application may display a scene with a three-dimensional cube. If the model output contains multiple lines of code as sub-parts over multiple iterations then each sub-part may be executed accordingly to affect the scene. For example, if the model output after several iterations included code to “make a cube”, “move it up,” and “make the block teal,” the scene may display a cube that then moves up and becomes teal. While method 600 is described using the example of natural language output and/or programmatic output, it will be appreciated that similar techniques may be applied to any of a variety of content types.

Flow progresses to operation 612, where the model output is compared to the intended user input. For example, it may be determined that a confidence level associated with the model output is below a predetermined threshold. As another example, while a multimodal machine learning model may attempt to generate content having a specific content type, the generated content may be invalid. Thus, a model may fail to generate adequate model output, such that user input associated with the inadequate model output may be identified and used as feedback for the machine learning model accordingly. Returning to the example of programmatic output, the resulting model output may be syntactically and/or semantically invalid, such that it is not usable to affect application behavior. In such instances, an indication may be provided that a user input was not understood correctly as the model output did not correspond to the intended user input. In such instances, flow may progress to operation 614, where an update to the multimodal generative platform (e.g., multimodal generative platform 152) may be provided. In instances, the updates may be to a prompt store (e.g., prompt store 174) a state bag (state bag 178) if maintained at the multimodal generative platform, and/or to the training data store (e.g., training data store 176). Updates may be provided in the form of additional programmatic code which correspond to the intent of the user input. The user input and associated model output may be stored for subsequent use as training data so as to improve model performance in the future. In such instances, the flow would progress to operation 604 where user may input the same request again to determine if the model produces adequate model output based on the intended input. If the output does correspond to user input, then flow terminates at end operation 616.

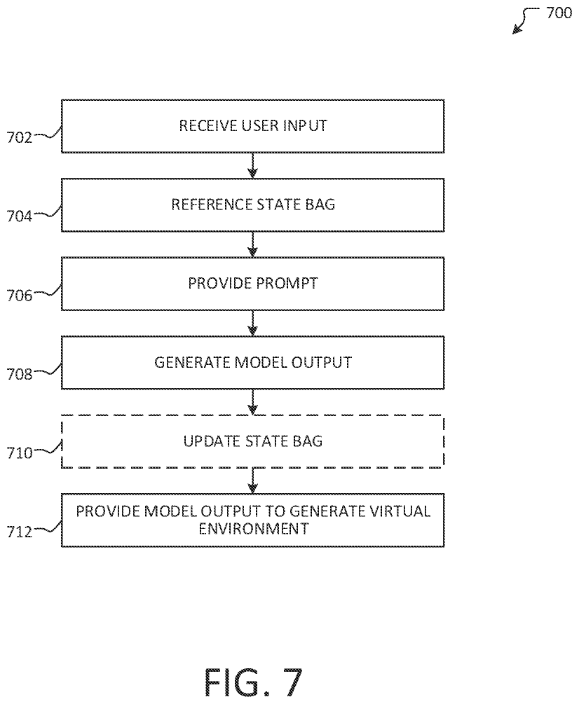

FIG. 7 illustrates an overview of an example method for utilizing a multimodal generative model to generate model output according to aspects described herein. In examples, aspects of method 700 are performed by a model interaction manager, such as model interaction manager 160 or model interaction manager 164 as well as other components discussed above with respect to FIG. 1B.

Method 700 begins at operation 702, where user input is received. The user input may be received by the request processor (e.g., request processor 170) from the model interaction manager (e.g., model interaction manager 160. Aspects of operation 702 are similar to those discussed above with respect to operation 602 of method 600 and are therefore not necessarily redescribed in detail below.

Flow progresses to operation 704, where the state bag is referenced based on the user input. Based on the user input, the state bag may be referenced to obtain, update, create, delete, and/or cancel a pre-existing object and/or a behavior of a pre-existing object as well as create a relationship between an object in the state bag and another object in the state bag or a new object. The request processor (e.g., request processor 170) may utilize the context of the user input to determine which object is referenced in the user input based on the semantics of previous user inputs and model outputs. For example, the user input may be “Now make it spin”. The request processor may utilize the semantics of a previous user input and model output to obtain “cube” as the indirect reference for “it”. Additionally, the request processor may utilize the semantics of the previous user input and model output to select a reference object despite the fact that the user input may contain a misspelling of a word or reference the object using contextual clues. For example, the second user input may be “make the block teal”. There may not be an object stored within the state bag named “block”. However, the semantics of “the block” indicate the user input intended a pre-existing object to be modified. The request processor may recognize that a “block” is a related synonym of “cube” and may utilize this contextual clue to obtain the cube from the state bag. In another instance, the user input may be “move the cbue up”. The request processor may recognize the misspelling of “cube” and obtain the cube stored in the state bag. In instances where the state bag is maintained on the client side at the computing device (e.g., computing device 174), the reference to the state bag may be a request from the request processor (e.g., request processor 170) to the model interaction manager (e.g., model interaction manager 160) for information about an object which may be stored in the state bag.

Flow progresses to operation 706, where a prompt is provided as input. A request processor (e.g., request processor 170), having received a user input, may access a prompt store (e.g., prompt store 174) to obtain a prompt applicable to the user input and provide the prompt to prime a machine learning engine (e.g., machine learning engine 172). A prompt may be an example of a type of model input, such as a text comment, coupled with an associated programmatic code segment similar to the expected model output from a machine learning engine (e.g., machine learning engine 172). A prompt may be designed as a comment because the programmatic code utilized by the machine learning engine, may recognize that a comment is a description of the programmatic code which follows it. In instances with multiple iterations and/or where an object from the state bag has been obtained, the programmatic code from the prompt may be appended to the end of the programmatic code associated with the object from the state bag. For example, the user input may be natural language command “Move the cube up”. An applicable prompt for the user input may be the comment “/* Move the cube up */” and sample programmatic code for the user input may be “position.y+=100”. The prompt would be appended to the programmatic code stored with the cube object from the state bag such that the code provided as input to prime the machine learning engine would be “state.cube.position.y+=100”.

Flow progresses to operation 708, where a model output is generated based on the prompt. The model output may be generated by the machine learning engine (e.g., machine learning engine 172) based on the prompt provided at operation 706. The model output may be new and/or distinct from the associated programmatic code provided to prime the machine learning engine in the prompt, because the machine learning engine may produce new programmatic code as model output responsive to the user input. Additionally, contained within the code may be examples of APIs which may be used to generate the model output. For example, the programmatic code associated with the prompt may be “state.cube.position.y+=100”. The model output may be new programmatic code “state.cube.position.y+=1” which though similar, is new and/or distinct from the associated programmatic code in the prompt.

Flow progresses to operation 710, where a state bag may be updated based on the model output. In instances where the state bag (e.g., state bag 178) is maintained on the server side at the multimodal generative platform (e.g., multimodal generative platform 152), the state bag may be updated to store an object generated as part of the model output from operation 710. The operation 608 may be optional and for this reason is shown with a dashed box to indicate it is not a required step of the method. For instance, the state bag may be maintained on the client side at the computing device (e.g., computing device 154) and updated accordingly. Aspects of operation 710 are similar to those discussed above with respect to operation 608 of method 600 and are therefore not necessarily redescribed in detail.

At operation 712, where model output is provided to generate a virtual environment. The new programmatic code generated by the second model output may be returned to the model interaction manager (e.g., model interaction manager 160), where it may be executed or otherwise processed to adapt a virtual environment. The model output may be programmatic code with which to add, remove, or otherwise adapt objects, scenes, and actions within a virtual environment according to aspects described herein, among other content. Flow terminates at operation 712.

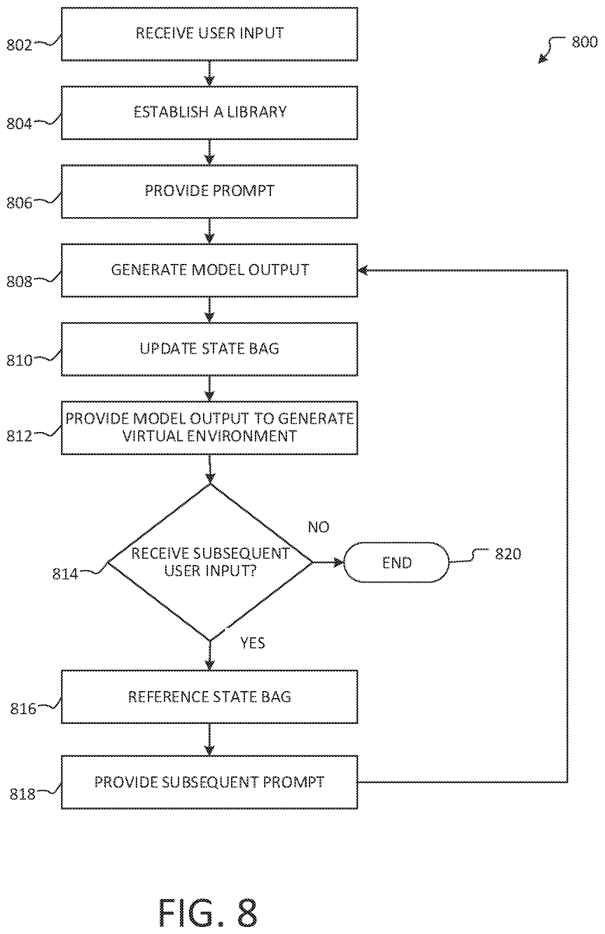

FIG. 8 illustrates an overview of an example method 800 for receiving multiple user inputs by a multimodal generative model and generating multiple model outputs, according to aspects described herein. In examples, aspects of method 800 are performed by a model interaction manager, such as model interaction manager 160 or model interaction manager 164 as well as other components discussed above with respect to FIG. 1B.

Method 800 begins at operation 802, where a user input is received. The user input may be received for example by a request processor (e.g., request processor 170). The user input may be a command to create programmatic code as the basis for a series of commands over multiple iterations which may generate a scene and actions within a virtual environment. For example, the user input may be the command “Make a cube” while subsequent user inputs may be “move the cube up”.

Flow progresses to operation 804, where the library is established. The initial programmatic code that is associated with the user input, may establish the asset library from which sample code for assets may be referenced. For example, the user input “make a cube” may become the comment “/* Make a cube */” with the programmatic code “state.cube=BABYLON.MeshBuilder.CreateBox(“cube”, {size: 1}, scene);” which establishes BabylonJS as the asset library. A library may be a scripting language framework utilizing asset libraries (e.g., BabylonJS) for building a virtual environment through commands translated into programmatic code. The library may be contained within the prompt store (e.g., prompt store 174).

Flow progresses to operation 806, where a prompt is provided. A request processor (e.g., request processor 170), having received a user input, may access a prompt store (e.g., prompt store 174) to obtain a prompt applicable to the user input. The prompt may be provided as input to prime a machine learning engine (e.g., machine learning engine 172) to generate model output. A prompt may be an example of a type of model input, such as a text comment coupled with an associated programmatic code, segment similar to the expected model output from a machine learning engine (e.g., machine learning engine 172). For example, the user input may be the command “Make a cube”. An applicable prompt may be the comment “/* Make a cube */” and sample programmatic code may be “state.cube=BABYLON.MeshBuilder.CreateBox(“cube”, {size: 100}, scene);” which would be input to a machine learning engine.

Flow progresses to operation 808, where model output is generated based on the prompt received. The prompt may be utilized to prime a machine learning engine (e.g., machine learning engine 172) to generate new programmatic code as a model output. The model output is new and/or distinct from the associated programmatic code provided in the prompt. For example, the first user input may be the command “Make a cube”. An applicable prompt may be the comment “/* Make a cube */” and associated programmatic code may be “state.cube=BABYLON.MeshBuilder.CreateBox(“cube”, {size: 100}, scene);” which would be input to a machine learning engine to prime it to generate similar but new programmatic code as a model output. The model output may be new programmatic code “state.cube=BABYLON.MeshBuilder.CreateBox(“cube”, {size: 1}, scene);” which though similar, is new and/or distinct from the associated programmatic code in the prompt.

Flow progresses to operation 810, where the state bag may be utilized to store an object generated as part of the model output from operation 808. The state bag (e.g., state bag 178) may be an empty object state bag updated to store objects of programmatic code generated by the machine learning engine (e.g., machine learning engine 172) as part of the model output. For example, in the first model output of operation 808, the “cube” object may be stored in the state bag for reference later by the machine learning engine. Over multiple iterations, the “cube” may be updated as a “teal cube” or as a “spinning teal cube” based on the user inputs to the machine learning engine.

Flow progresses to operation 812, where the model output is executed to produce a virtual environment. The new programmatic code generated by the model output may be returned to the model interaction manager (e.g., model interaction manager 160) to be executed on the application (e.g., application 158) to produce or otherwise adapt the virtual environment. Aspects of operation 812 are similar to those discussed above with respect to operation 712 of method 700 and are therefore not necessarily redescribed in detail.

Flow progresses to operation 814, where it is determined if a subsequent user input is received. If no subsequent user input is received, flow terminates at end operation 820. Alternatively, if a subsequent user input is received it may be that the request processor (e.g., request processor 170) received a subsequent user input from the model interaction manager (e.g., model interaction manager 160) in the form of user input, previously described at operation 802. The subsequent user input may contain a natural language reference back to an object stored in the state bag (e.g., state bag 178) at operation 810. The reference in the command may be a direct reference that specifically refers to the object in the state bag. For example, the user input may be “Move the cube up” which is a direct reference to the cube object stored in operation 810. Alternatively, the reference in the command may be an indirect reference which does not specifically name the object but uses context to reference the object. For example, the user input may be “Now make it spin” where “it” is an indirect reference to the cube object stored in operation 810. In some instances, the received user input may be multimodal, for example including multiple content types.

Flow progresses to operation 816, where the state bag is referenced based on the second user input. The request processor (e.g., request processor 170) may utilize the context of the subsequent user input to determine which object is referenced in the user input based on the semantics of previous user inputs and model outputs as well as newly updated programmatic code stored with the object in the state bag (e.g., state bag 178). Aspects of operation 816 are similar to those discussed above with respect to operation 704 of method 700 and are therefore not necessarily redescribed in detail.

Flow progresses to operation 818, where a subsequent prompt is provided. A request processor (e.g., request processor 170), having received a subsequent user input, may access a prompt store (e.g., prompt store 174) to obtain a subsequent prompt applicable to the subsequent user input. The subsequent prompt may be provided to prime the machine learning engine (e.g., machine learning engine 172). For example, the subsequent user input may be natural language command “Move the cube up”. An applicable prompt for the subsequent user input may be the comment “/* Move the cube up */” and sample programmatic code for the subsequent user input may be “position.y+=100”. The subsequent prompt would be appended to the programmatic code stored with the cube object from the state bag (e.g., state bag 178) obtained from operation 816, such that the code provided as input to the machine learning engine would be “state.cube.position.y+=100”.

From operation 818 flow progresses as a loop to operation 808 through operation 814 and so on until no subsequent user inputs are received. Aspects of operation 808 through 812 are similar to those discussed above with respect to the same operations and are therefore not necessarily redescribed in detail. As an example of the possible flow through the operations, the model output generated at operation 808 may be “state.cube.position.y+=1” which though similar, is new and/or distinct from the associated programmatic code from the example in operation 818. The programmatic code associated with the “cube” previously stored in the state bag (e.g., state bag 178) may be updated at operation 810 to reflect the new position of the “cube” while the originally stored programmatic code may be deleted and removed from the state bag. The model output may be provided to generate the virtual environment with the “cube” at the new position.

Over multiple iterations through the method 800, there may be multiple objects stored in the state bag that may be updated, created, deleted, and/or canceled, relationships may be created between the objects, and/or behaviors may be established that modify the objects. In such instances, if a further iteration of the “cube” was generated, such as a “teal cube”, that maintained the stored position of the “cube”, then the programmatic code from the subsequent model output may be appended to the programmatic code that defined the position of the cube from the earlier model output. In another instance, if an object was stored in the state bag such as a ball, a relationship may be created by a subsequent user input such as “put the ball on top of it” where “it” is a reference to the previously stored “cube”. In such an instance, the programmatic code with the “block on top of the ball” may be stored as a relationship or it may modify the existing programmatic code associated with both the “ball” and the “cube.

FIGS. 9-11-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, described herein.

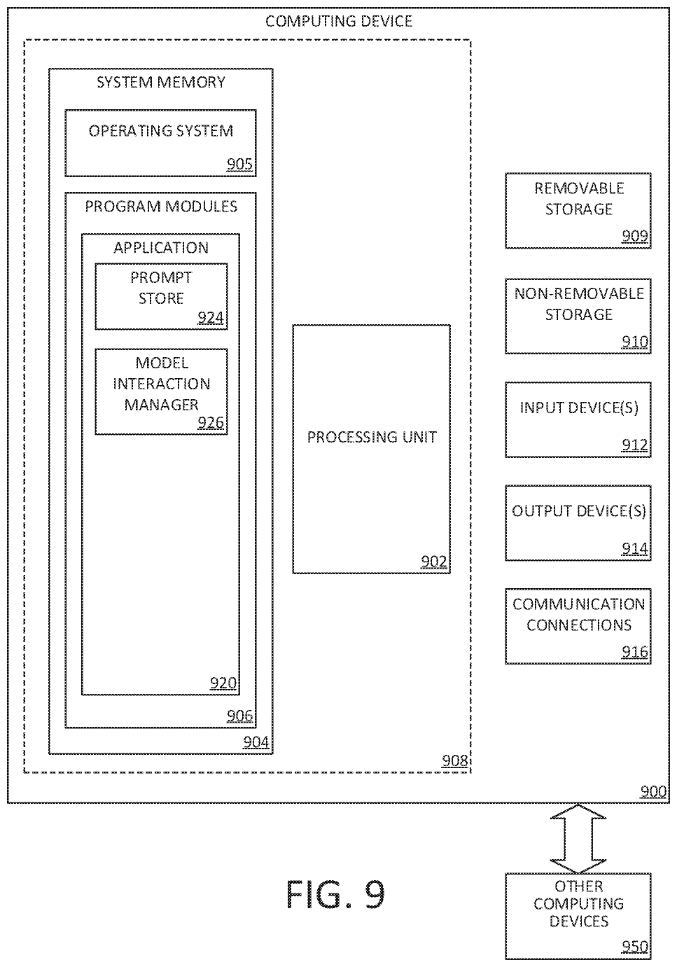

FIG. 9 is a block diagram illustrating physical components (e.g., hardware) of a computing device 900 with which aspects of the disclosure may be practiced. The computing device components described below may be suitable for the computing devices described above, including devices 104, 106, 154, and/or 156, as well as one or more devices associated with multimodal generative platform 102 and/or 152 discussed above with respect to FIGS. 1A and 1B. In a basic configuration, the computing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combination of such memories.

The system memory 904 may include an operating system 905 and one or more program modules 906 suitable for running software application 920, such as one or more components supported by the systems described herein. As examples, system memory 904 may store prompt store 924 and model interaction manager 926. The operating system 905, for example, may be suitable for controlling the operation of the computing device 900.

Furthermore, embodiments of the disclosure may be practiced in conjunction with a graphics library, other operating systems, or any other application program and is not limited to any particular application or system. This basic configuration is illustrated in FIG. 9 by those components within a dashed line 908. The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by a removable storage device 909 and a non-removable storage device 910.

As stated above, a number of program modules and data files may be stored in the system memory 904. While executing on the processing unit 902, the program modules 906 (e.g., application 920) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 900 may also have one or more input device(s) 912 such as a keyboard, a mouse, a pen, a sound or voice input device, a touch or swipe input device, etc. The output device(s) 914 such as a display, speakers, a printer, etc. may also be included. The aforementioned devices are examples and others may be used. The computing device 900 may include one or more communication connections 916 allowing communications with other computing devices 950. Examples of suitable communication connections 916 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 909, and the non-removable storage device 910 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. Any such computer storage media may be part of the computing device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

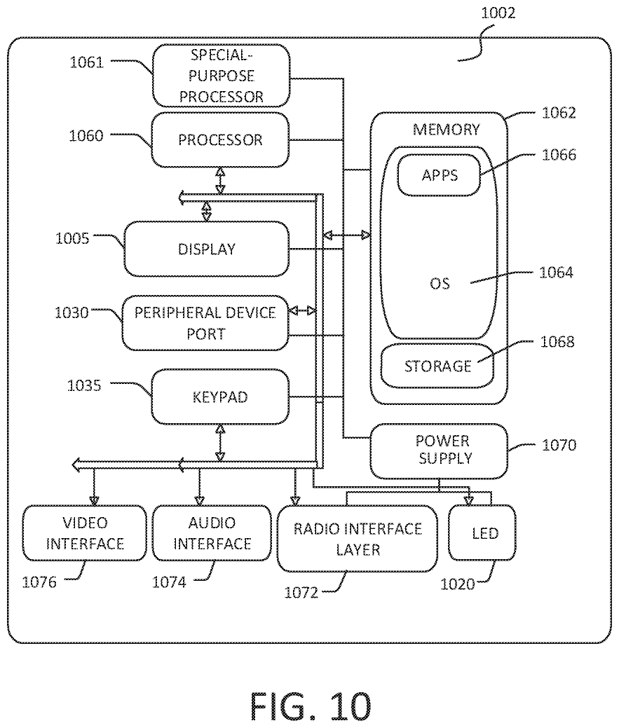

FIG. 10 is a block diagram illustrating the architecture of one aspect of a computing device 1000 (not shown) for example, a mobile telephone, a smart phone, wearable computer (such as a smart watch), a tablet computer, a laptop computer, and the like, with which embodiments of the disclosure may be practiced. In some aspects, the client may be a mobile computing device. That is, the computing device 1000 can incorporate a system (e.g., an architecture) 1002 to implement some aspects. In one embodiment, the system 1002 is implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as e-mail or other messages used by an e-mail application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000 described herein.

The system 1002 has a power supply 1070, which may be implemented as one or more batteries. The power supply 1070 might further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 1020 may be used to provide visual notifications, and/or an audio interface 1074 may be used for producing audible notifications via the audio transducer 1025. In the illustrated embodiment, the visual indicator 1020 is a light emitting diode (LED) and the audio transducer 1025 is a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 1025, the audio interface 1074 may also be coupled to a microphone to receive audible input, such as to facilitate a telephone conversation. In accordance with embodiments of the present disclosure, the microphone may also serve as an audio sensor to facilitate control of notifications, as will be described below. The system 1002 may further include a video interface 1076 that enables an operation of an on-board camera 1030 to record still images, video stream, and the like.

A mobile computing device 1000 implementing the system 1002 may have additional features or functionality. For example, the mobile computing device 1000 may also include additional data storage devices (removable and/or non-removable) such as, magnetic disks, optical disks, or tape. Such additional storage is illustrated in FIG. 10 by the non-volatile storage area 1068.

Data/information generated or captured by the computing device 1000 and stored via the system 1002 may be stored locally on the computing device 1000, as described above, or the data may be stored on any number of storage media that may be accessed by the device via the radio interface layer 1072 or via a wired connection between the mobile computing device 1000 and a separate computing device associated with the computing device 1000, for example, a server computer in a distributed computing network, such as the Internet. As should be appreciated such data/information may be accessed via the computing device 1000 via the radio interface layer 1072 or via a distributed computing network. Similarly, such data/information may be readily transferred between computing devices for storage and use according to well-known data/information transfer and storage means, including electronic mail and collaborative data/information sharing systems.

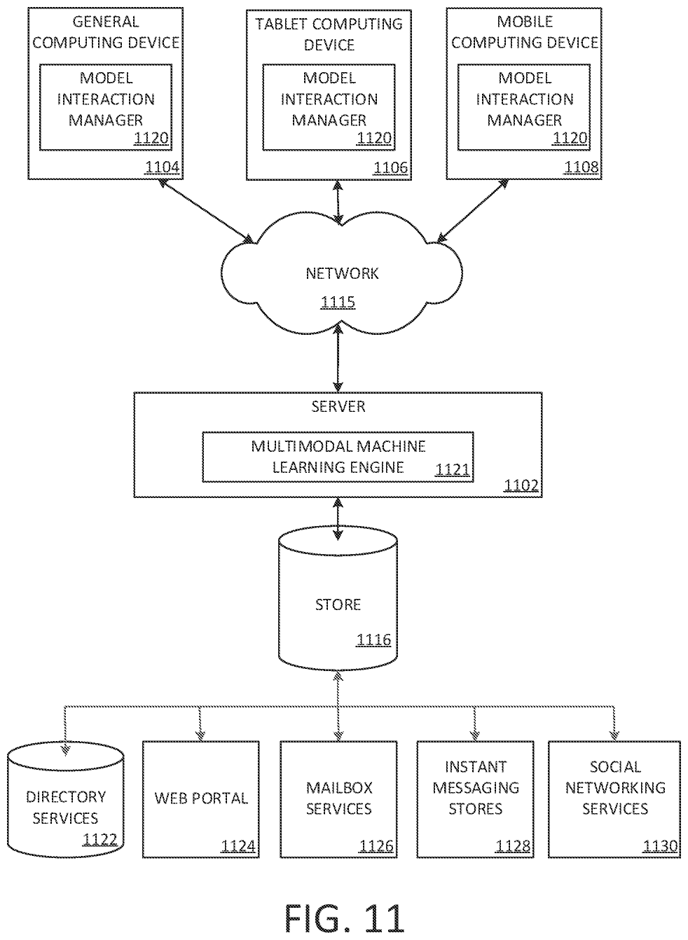

FIG. 11 illustrates one aspect of the architecture of a system for processing data received at a computing system from a remote source, such as a personal computer 1104, tablet computing device 1106, or mobile computing device 1108, as described above. Content displayed at server device 1102 may be stored in different communication channels or other storage types. For example, various documents may be stored using a directory service 1122, a web portal 1124, a mailbox service 1126, an instant messaging store 1128, or a social networking site 1130.

A model interaction manager 1120 may be employed by a client that communicates with server device 1102, and/or multimodal machine learning engine 1121 may be employed by server device 1102. The server device 1102 may provide data to and from a client computing device such as a personal computer 1104, a tablet computing device 1106 and/or a mobile computing device 1108 (e.g., a smart phone) through a network 1115. By way of example, the computer system described above may be embodied in a personal computer 1104, a tablet computing device 1106 and/or a mobile computing device 1108 (e.g., a smart phone). Any of these embodiments of the computing devices may obtain content from the store 1116, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

As will be understood from the foregoing disclosure, one aspect of the technology relates to a system comprising: at least one processor; and memory storing instructions that, when executed by the at least one processor, causes the system to perform a set of operations. The set of operations comprises: receiving an input associated with a virtual environment; determining, based on the received input, a model output associated with a multimodal machine learning model; and executing the model output to programmatically affect the virtual environment according to the received input. In an example, the set of operations further comprises: determining the model output does not correspond to the input; and updating a multimodal generative platform associated with the multimodal machine learning model. In another example, updating the multimodal generative platform further comprises: providing an indication to update a prompt store and a training data store of the multimodal generative platform. In a further example, the model output is associated with a state bag that indicates a state of an object in the virtual environment associated with the model output. In yet another example, the set of operations further comprises: updating the state bag based on an object associated with the model output, thereby enabling the object to be indirectly referenced by a subsequent input. In a further still example, executing the model output to programmatically affect the virtual environment further comprises one of: generating a new object within the virtual environment; updating an existing object within the virtual environment; removing the existing object from the virtual environment; or causing an object of the virtual environment to perform an associated action. In another example, the input includes one or more of textual input, spoken input, or gestural input. In a further example, the model output further comprises programmatic code for a library associated with the virtual environment for affecting the virtual environment.

In another aspect, the technology relates to a method for affecting a virtual environment based on natural language input. The method comprises: obtaining an input associated with the virtual environment; generating, for the input, a model output to affect the virtual environment based on the prompt, wherein the model output updates a state bag associated with the virtual environment; and providing the model output for processing by a computing device to update the virtual environment. In an example, the state bag is updated to include an object associated with the model output, thereby enabling the object to be indirectly referenced by a subsequent input. In another example, the model output is generated based at least in part on a prompt associated with a library for the virtual environment. In a further example, the library comprises a scripting language framework for affecting the virtual environment through programmatic code. In yet another example, the prompt comprises a text comment coupled associated with a programmatic code segment to affect the virtual environment according to the text comment. In a further still example, the method further comprises: obtaining a subsequent input, wherein the subsequent input references an object of the state bag; generating a subsequent model output based on the subsequent input and the state bag; and providing the subsequent model output for processing by the computing device to update the virtual environment according to the subsequent input.

In a further aspect, the technology relates to a method for affecting a virtual environment based on natural language input. The method comprises: receiving an input associated with the virtual environment; determining, based on the received input, a model output of a multimodal machine learning model; and executing the model output to programmatically affect the virtual environment according to the received user input. In an example, the method further comprises: determining the model output does not correspond to the input; and updating a multimodal generative platform associated with the multimodal machine learning model. In another example, updating the multimodal generative platform further comprises: providing an indication to update a prompt store and a training data store of the multimodal generative platform. In a further example, the model output is associated with a state bag that indicates a state of an object in the virtual environment associated with the model output. In yet another example, the method further comprises updating the state bag based on an object associated with the model output, thereby enabling the object to be indirectly referenced by a subsequent input. In a further still example, executing the model output to programmatically affect the virtual environment further comprises one of: generating a new object within the virtual environment; updating an existing object within the virtual environment; removing the existing object from the virtual environment; or causing an object of the virtual environment to perform an associated action.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
receiving an input associated with a virtual environment;
determining, based on the received input, a model output associated with a multimodal machine learning model; and
executing the model output to programmatically affect the virtual environment according to the received input.

2. The system of claim 1, wherein the set of operations further comprises:
determining the model output does not correspond to the input; and
updating a multimodal generative platform associated with the multimodal machine learning model.

3. The system of claim 2, wherein updating the multimodal generative platform further comprises:
providing an indication to update a prompt store and a training data store of the multimodal generative platform.

4. The system of claim 1, wherein the model output is associated with a state bag that indicates a state of an object in the virtual environment associated with the model output.

5. The system of claim 4, wherein the set of operations further comprises:
updating the state bag based on an object associated with the model output, thereby enabling the object to be indirectly referenced by a subsequent input.

6. The system of claim 1, wherein executing the model output to programmatically affect the virtual environment further comprises one of:
generating a new object within the virtual environment;
updating an existing object within the virtual environment;
removing the existing object from the virtual environment; or
causing an object of the virtual environment to perform an associated action.

7. The system of claim 1, wherein the input includes one or more of textual input, spoken input, or gestural input.

8. The system of claim 1, wherein the model output further comprises programmatic code for a library associated with the virtual environment for affecting the virtual environment.

9. A method for affecting a virtual environment based on natural language input, the method comprising:
obtaining an input associated with the virtual environment;
generating, for the input, a model output to affect the virtual environment based on the prompt, wherein the model output updates a state bag associated with the virtual environment; and
providing the model output for processing by a computing device to update the virtual environment.

10. The method of claim 9, wherein the state bag is updated to include an object associated with the model output, thereby enabling the object to be indirectly referenced by a subsequent input.

11. The method of claim 9, wherein the model output is generated based at least in part on a prompt associated with a library for the virtual environment.

12. The method of claim 11, wherein the library comprises a scripting language framework for affecting the virtual environment through programmatic code.

13. The method of claim 11, wherein the prompt comprises a text comment coupled associated with a programmatic code segment to affect the virtual environment according to the text comment.

14. The method of claim 9, further comprising:
obtaining a subsequent input, wherein the subsequent input references an object of the state bag;
generating a subsequent model output based on the subsequent input and the state bag; and
providing the subsequent model output for processing by the computing device to update the virtual environment according to the subsequent input.

15. A method for affecting a virtual environment based on natural language input, the method comprising:
receiving an input associated with the virtual environment;
determining, based on the received input, a model output of a multimodal machine learning model; and
executing the model output to programmatically affect the virtual environment according to the received user input.

16. The method of claim 15, further comprising:
determining the model output does not correspond to the input; and
updating a multimodal generative platform associated with the multimodal machine learning model.

17. The method of claim 16, wherein updating the multimodal generative platform further comprises:
providing an indication to update a prompt store and a training data store of the multimodal generative platform.

18. The method of claim 15, wherein the model output is associated with a state bag that indicates a state of an object in the virtual environment associated with the model output.

19. The method of claim 18, further comprising:
updating the state bag based on an object associated with the model output, thereby enabling the object to be indirectly referenced by a subsequent input.

20. The method of claim 15, wherein executing the model output to programmatically affect the virtual environment further comprises one of:
generating a new object within the virtual environment;
updating an existing object within the virtual environment;
removing the existing object from the virtual environment; or
causing an object of the virtual environment to perform an associated action.
